(19) United States
(12) Patent Application Publication
(10) Pub. No.: US 2023/0152724 A1
(43) Pub. Date: May 18, 2023

(54) TONER, TONER STORAGE UNIT, IMAGE FORMING APPARATUS, AND IMAGE FORMING METHOD

(71) Applicants: Suzuka KARATO, Shizuoka (JP); Mitsuaki HIROSE, Shizuoka (JP); Hiroshi YAMADA, Shizuoka (JP); Yohichi KITAGAWA, Shizuoka (JP); Tsukiko TAKAHASHI, Shizuoka (JP)

(72) Inventors: Suzuka KARATO, Shizuoka (JP); Mitsuaki HIROSE, Shizuoka (JP); Hiroshi YAMADA, Shizuoka (JP); Yohichi KITAGAWA, Shizuoka (JP); Tsukiko TAKAHASHI, Shizuoka (JP)

(21) Appl. No.: 17/983,408

(22) Filed: Nov. 9, 2022

(30) Foreign Application Priority Data
Nov. 16, 2021 (JP) 2021-186404
Aug. 23, 2022 (JP) 2022-132747

(51) Int. Cl. G03G 9/087; G03G 9/08

(52) U.S. Cl. CPC G03G 9/08711; G03G 9/0819; G03G 9/0825; G03G 2215/16

(57) ABSTRACT

A toner includes toner base particles each including a binder resin and a releasing agent, resin particles, and an external additive. Resin particles, from among the resin particles in the toner, and the external additive are deposited on a surface of each of the toner base particles. A standard deviation of a distance between resin particles next to one another on the surface is less than 600 nm, the resin particles next to one another being from among the resin particles deposited on the surface. The external additive includes primary particles each standing alone and non-spherical cohesive particles each including cohered primary particles. A proportion of the primary particles each standing alone per 1,000 particles of the external additive is 30% or less, the particles of the external additive in the per 1,000 particles being the primary particles each standing alone and the cohesive particles.

### CROSS-REFERENCE TO RELATED APPLICATION

The present application claims priority under 35 U.S.C. § 119 to Japanese Patent Application No. 2021-186404, filed Nov. 16, 2021, and Japanese Patent Application No. 2022-132747, filed Aug. 23, 2022, the contents of which are incorporated herein by reference in their entirety.

### BACKGROUND OF THE INVENTION

### 1. Field of the Invention

The disclosures herein generally relate to a toner, a toner storage unit, an image forming apparatus, and an image forming method.

### 2. Description of the Related Art

In recent years, the following characteristics or properties of toners have been desired. Namely, desired characteristics or properties of the toners are small particle sizes and hot offset resistance for forming high-quality output images; low-temperature fixability for achieving energy saving; and heat-resistant storage stability for resisting high temperature and high humidity conditions during storage or transportation after production of the toner. Improvement in low-temperature fixability of a toner is particularly important because energy consumption during fixing constitutes the majority of energy consumption of an entire image formation process. Moreover, a color print-on-demand (POD) printer used in the field of production printing (PP) is desired to achieve high image quality, high durability, high reliability, and high productivity over a long period of time.

Materials having low melting points are used to produce a toner for assuring low-temperature fixability of the toner. The toner produced using the materials having low melting points has problems, such as decrease in image density, uneven transfer, and poor reproducibility of fine lines. The above-described problems occur because a resin used in a toner base material itself deforms not only during a long-term storage in a standing state, but also during continuous printing as mechanical loads (e.g., stirring or compression) are applied to the toner inside a printer. In addition, another problem is that an external additive is embedded in the toner base particles to increase adhesion force between the toner and members of the printer, which makes cleaning of the toner with a cleaning blade difficult.

For example, the following toner is proposed for assuring durability during continuous printing. The toner includes toner base particles and an external additive, where projections are formed at a surface of each toner base particle, and the external additive includes alumina particles to prevent adhesion of the toner due to electrostatic force (see, for example, Japanese Unexamined Patent Application Publication No. 2019-158943).

Moreover, the following toner including toner base particles is proposed. Each toner base particle includes a core particle, inorganic particles, and a thermoset resin, where the inorganic particles are deposited on a surface of the core particle, and the inorganic particles are covered with the thermoset resin constituting a shell (see, for example, Japanese Unexamined Patent Application Publication No. 2015-087597).

A toner having low-temperature fixability and heat resistance is proposed. According to the proposed toner, durability and flowability are both achieved by appropriately controlling the order of mixing silica particle groups, which have mutually different particle diameters of silica particles, during an external additive process to control a state of the external additive particles embedding in each toner base particle (see, for example, Japanese Unexamined Patent Application Publication No. 2013-105153).

A toner for developing a latent electrostatic image is proposed. According to the proposed toner, a layered inorganic mineral serving as a charge-controlling agent, and non-spherical insulating inorganic particles are deposited on surfaces of toner particles. In the layered inorganic mineral, interlayer ions are modified with organic ions. The non-spherical insulating inorganic particles are secondary particles in each of which primary particles are cohered. Owing to the above-described configuration, deteriorations in transfer properties, filming resistance, and flowability of the toner, which may occur when the toner is used in an ultrahigh-speed printing system, are prevented, and charging of the toner is stabilized (see, for example, Japanese Unexamined Patent Application Publication No. 2014-178547).

### SUMMARY OF THE INVENTION

In one embodiment, a toner includes toner base particles, resin particles, and an external additive. Each of the toner base particles includes a binder resin and a releasing agent. The resin particles, from among the resin particles included in the toner, and the external additive are deposited on a surface of each of the toner base particles. A standard deviation of a distance between the resin particles next to one another on the surface of each of the toner base particles is less than 600 nm, where the resin particles next to one another are from among the resin particles deposited on the surface. The external additive includes primary particles each standing alone and non-spherical cohesive particles. Each of the non-spherical cohesive particles includes primary particles that are cohered. A proportion of the primary particles each standing alone per 1,000 particles of the external additive is 30% or less. The particles of the external additive in the per 1,000 particles of the external additive being the primary particles each standing alone and the non-spherical cohesive particles. The external additive included in the toner satisfies Formula (1) below.

$$\frac{{N}_{x}}{1 , 000} \times 100 \leq 30 \% \qquad Formula ( 1 )$$

In Formula (1), Nₓ is the number of the primary particles standing alone.

### BRIEF DESCRIPTION OF THE DRAWINGS

FIG. 1 is a photograph depicting an example of an external additive of the toner of the present disclosure;

FIG. 2 is a photograph depicting an example of the external additive of the toner of the present disclosure;

FIG. 3 is a photograph depicting an example of an evaluation result of the external additive of Example 1;

FIG. 4 is a photograph depicting an example of an evaluation result of the external additive of Comparative Example 1;

FIG. 5 is a schematic view illustrating an example of a state of a surface of a particle of the toner of the present disclosure;

FIG. 6 is a schematic view illustrating an example of a toner storage unit of the present disclosure; and

FIG. 7 is a schematic view illustrating an example of an image forming apparatus of the present disclosure.

### DESCRIPTION OF THE PREFERRED EMBODIMENTS

In the following, embodiments of the present invention will be described with reference to the accompanying drawings.

Further, the present invention is not limited to these embodiments, but various variations and modifications may be made without departing from the scope of the present invention.

### (Toner)

The toner of the present disclosure includes toner base particles, resin particles, and an external additive. Each of the toner base particles includes a binder resin and a releasing agent. The resin particles, from among the resin particles included in the toner, and the external additive are deposited on a surface of each of the toner base particles. A standard deviation of a distance between the resin particles next to one another on the surface of each of the toner base particles is less than 600 nm, where the resin particles next to one another are from among the resin particles deposited on the surface. The external additive includes primary particles each standing alone and non-spherical cohesive particles. Each of the non-spherical cohesive particles includes primary particles that are cohered. A proportion of the primary particles each standing alone per 1,000 particles of the external additive is 30% or less, where the particles of the external additive in the per 1,000 particles of the external additive are the primary particles each standing alone and the non-spherical cohesive particles.

The external additive included in the toner of the present disclosure satisfies Formula (1) below, and preferably satisfies Formula (1-1) below.

$$\frac{{N}_{x}}{1 , 000} \times 100 \leq 30 \% \qquad Formula ( 1 )$$

$$\frac{{N}_{x}}{1 , 000} \times 100 \leq 20 \% \qquad Formula ( 1 - 1 )$$

In Formulae (1) and (1-1), Nₓ is the number of the primary particles standing alone.

In the present specification, a toner base particle on which resin particles and particles of an external additive are deposited is referred to as a toner particle. Namely, the toner particles constitute the toner of the present disclosure, and each toner particle includes the toner base particle, the resin particles, and the particles of the external additive, where the resin particles and the particles of the external additive are deposited on a surface of the toner base particle.

An object of the present disclosure is to provide a toner that can achieve both low-temperature fixability and heat-resistant storage stability at a high level, can prevent formation of image defects due to filming with maintaining excellent cleaning properties, can prevent uneven transfer during continuous printing, and can achieve excellent image density and reproducibility of fine lines.

The present disclosure can provide a toner that can achieve both low-temperature fixability and heat-resistant storage stability at a high level, can prevent formation of image defects due to filming with maintaining excellent cleaning properties, can prevent uneven transfer during continuous printing, and can achieve excellent image density and reproducibility of fine lines.

The toner of the present disclosure includes toner base particles, resin particles, and an external additive. The toner may further include other components according to the necessity.

According to the toner of the present disclosure, a standard deviation of a distance between the resin particles next to one another on a surface of each of the toner base particles is less than 600 nm, preferably 10 nm or greater and 250 nm or less, and more preferably 10 nm or greater and 100 nm or less. Owing to the above-mentioned standard deviation, the resin particles next to one another are evenly distributed. Therefore, the resin particles, which do not inhibit fixing, cover a surface of the toner base particle to make a surface of a resulting toner particle hard, which assures reliability (e.g., storage stability and adhesion) of the toner. Consequently, both low-temperature fixability and heat-resistant storage stability are achieved at a high level, excellent cleaning properties are maintained, and formation of image defects due to filming is prevented.

As a method of adjusting the standard deviation to less than 600 nm, for example, the resin particles are added during emulsification in a manner that a coverage rate of a surface of each of the toner base particles with the resin particles is to be 90% or greater, thereby densely depositing the resin particles on the surface of each of the toner base particles. Moreover, a distance between the resin particles is minimized by adjusting the average circularity of the toner base particles to efficiently deposit the resin particles.

According to the toner of the present disclosure, the external additive includes primary particles and non-spherical cohesive particles. Each non-spherical cohesive particle includes primary particles that are cohered. A proportion of the primary particles per 1,000 particles of the external additive is 30% or less. Owing to the above-mentioned proportion of the primary particles, the external additive particles are not easily embedded in toner base particles, durability can be assured during continuous printing, and uneven transfer can be prevented. Moreover, excellent image density and reproducibility of fine lines are achieved.

### <Resin Particles>

The resin particles are deposited on a surface of each of the toner base particles.

The average value of distances between the resin particles next to one another is preferably 10 nm or greater and 600 nm or less, and more preferably 20 nm or greater and 250 nm or less.

In the present disclosure, the distance between the resin particles next to one another is a distance between a center of one resin particle and a center of another resin particle next to the one particle. The center of the resin particle is a center point of an image of the resin particle obtained by observing the resin particle under a scanning electron microscope (SEM) and capturing the image of the resin particle.

The surface of the toner base particle is not completely flat, and has a slight curvature, i.e., the surface being curved. Therefore, the distance between the resin particles is not a distance determined by measuring a distance between the resin particles on the surface of the toner base particle. The distance between the resin particles is the minimum distance between the resin particles on an image obtained by capturing the resin particles on the surface of the toner base particle by means of a scanning electron microscope (SEM).

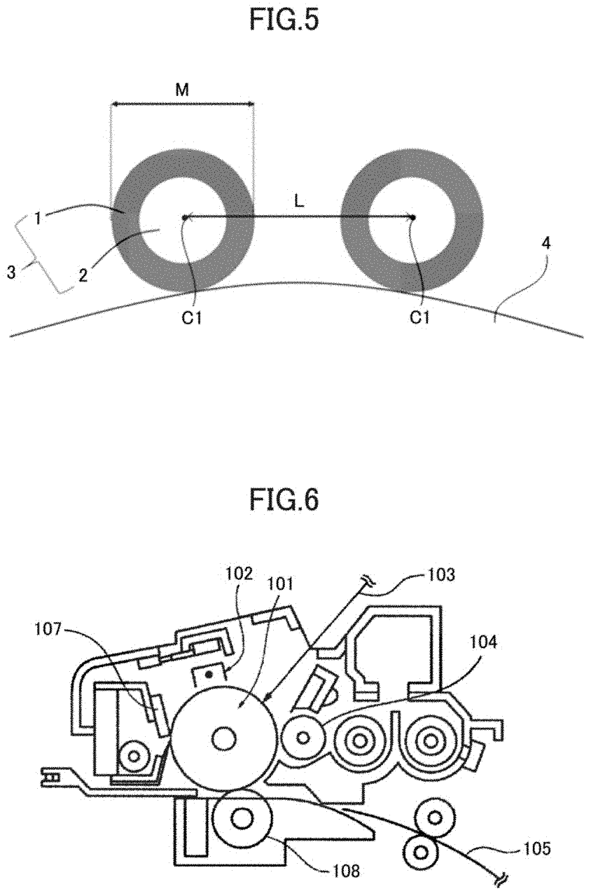

FIG. 5 is a schematic view depicting a state of a surface of a toner particle. Resin particles 3 are deposited on a surface of a toner base particle 4. The resin particle 3 includes a below-described core resin (b2) 2 and a below-described shell resin (b1) 1. C1 and C2 are centers of the resin particles 3. M is a volume average primary particle diameter of the resin particles 3. L is a distance between the resin particles 3 next to one another.

### <Measurement of Distance Between Resin Particles>

An average value of distances between resin particles, and the standard deviation of the distance between the resin particles are determined in the following manner with the toner particles processed to be in a state close to the toner base particles by removing the external additives as much as possible by a releasing method. The method of releasing the external additive is performed using ultrasonic waves.

### —Releasing Method of External Additive—

[1] A 100 mL screw vial is charged with 50 mL of a 5% by mass surfactant aqueous solution (product name: NOIGEN ET-165, available from DKS Co., Ltd.). To the solution, 3 g of the toner is added, and the mixture in the vial is gently agitated in up-down and left-right motion. Then, the resulting dispersion solution is stirred by means of a ball mill for 30 minutes to homogeneously disperse the toner in the dispersion solution.

[2] Then, ultrasonic energy is applied to the resulting dispersion solution for 60 minutes by means of an ultrasonic homogenizer (product name: Homogenizer, type: VCX750, CV33, available from SONICS & MATERIALS, INC.) with setting the output to 40 W.

### —Ultrasonic Wave Conditions—

Duration of application of vibration: continuous 60 minutes

### Amplitude: 40 W

Onset temperature of application of vibration: 23° C.±1.5° C.
Temperature during application of vibration: 23° C.±1.5° C.

[3] (1) The dispersion liquid is filtered by vacuum filtration using filter paper (product name: Quantitative filter paper (No. 2, 110 mm), available from Advantec Toyo Kaisha, Ltd.). The resulting filtration cake is washed twice with ion-exchanged water, followed by performing filtration to remove free additive particles. Then, the collected toner particles are dried.

(2) The toner particles collected in (1) are observed under a scanning electron microscope (SEM). First, a backscattered electron image is observed to detect the external additive and/or filler including Si particles.

(3) The image of (2) is binarized using image processing software (ImageJ) to eliminate the eliminate additive and/or filler particles.

Next, the section of the toner identical to the observation section in (2) is observed to acquire a secondary electron image. Since the resin particles cannot be detected on the backscattered electron image and can be detected only on the secondary electron image, the secondary electron image is compared to the image acquired in (3) to determine, as the resin particles, the particles present in the regions other than the regions of the residual external additive and/or filler particles (other than the regions excluded in (3)). A distance between the resin particles next to one another (i.e., a distance between a center of one resin particle and a center of another resin particle) is measured using the image processing software.

The measurement of the distance is performed on 100 binarized images (one toner particle per image), and an average value of the measured values is determined as the distance between the resin particles.

The standard deviation of the distance between the resin particles can be calculated by the following mathematical formula, where x is a distance between the resin particles.

$$\sqrt{\frac{1}{n - 1}} {\sum }_{k = 1}^{n} ( {x}_{i} - \overline{x} )$$

### [Image Capturing Conditions]

Scanning electron microscope: SU-8230 (available from Hitachi High-Tech Corporation)
Image capturing magnification: 35,000×
Captured image: secondary electron (SE(L)) image and backscattered electron (BSE) image
Acceleration voltage: 2.0 kV
Acceleration current: 1.0 μA
Probe current: Normal
Focus mode: UHR

### WD: 8.0 mm

The volume average primary particle diameter of the resin particles is preferably 5 nm or greater and 100 nm or less, and more preferably 10 nm or greater and 50 nm or less. When the volume average primary particle diameter is 5 nm or greater and 100 nm or less, a resulting toner has excellent low-temperature fixability.

For example, the volume average primary particle diameter can be measured by observing an image captured by means of a scanning electron microscope (SEM).

Each of the resin particles (may be referred to as “resin particles (B)” hereinafter) preferably includes a core resin (i.e., a core), and a shell resin (i.e., a shell) covering at least part of the core resin. More preferably, each resin particle is made up of a core resin and a shell resin. Even more preferably, each resin particle includes a vinyl-based unit made up of a resin (b1) and a resin (b2).

The shell resin (may be referred to as the “resin (b1)” hereinafter) and the core resin (may be referred to as the “resin (b2)” hereinafter) are each preferably a polymer obtained through homopolymerization or copolymerization of a vinyl monomer.

Examples of the vinyl monomer include the following (1) to (10).

### (1) Vinyl Hydrocarbon

Examples of the vinyl hydrocarbon include (1-1) an aliphatic vinyl hydrocarbon, (1-2) an alicyclic vinyl hydrocarbon, and (1-3) an aromatic vinyl hydrocarbon.

### (1-1) Aliphatic Vinyl Hydrocarbon

Examples of the aliphatic vinyl hydrocarbon include an alkene and an alkadiene.

Examples of the alkene include ethylene, propylene, and α-olefin.

Examples of the alkadiene include butadiene, isoprene, 1,4-pentadiene, 1,6-hexadiene, and 1,7-octadiene.

### (1-2) Alicyclic Vinyl Hydrocarbon

Examples of the alicyclic vinyl hydrocarbon include a monocycloalkene or dicycloalkene, and an alkadiene. Specific examples of the alicyclic vinyl hydrocarbon include (di)cyclopentadiene, and terpene.

### (1-3) Aromatic Vinyl Hydrocarbon

Examples of the aromatic vinyl hydrocarbon include styrene, and hydrocarbyl (e.g., alkyl, cycloalkyl, aralkyl and alkenyl)-substituted styrene. Specific examples of the hydrocarbyl-substituted styrene include α-methylstyrene, 2,4-dimethylstyrene, and vinyl naphthalene.

### (2) Carboxyl Group-Containing Vinyl Monomer and Salts of Carboxyl Group-Containing Vinyl Monomer

Examples of the carboxyl group-containing vinyl monomer and salts of the carboxyl group-containing vinyl monomer include a C3-C30 unsaturated monocarboxylic acid (salt), an unsaturated dicarboxylic acid (salt), anhydride (salt) of the foregoing monomers, and monoalkyl (C1-C24) esters of the foregoing monomers.

Specific examples of the carboxyl group-containing vinyl monomer include: carboxyl group-containing vinyl monomers, such as (meth)acrylic acid, maleic acid (anhydride), monoalkyl maleate, fumaric acid, monoalkyl fumarate, crotonic acid, itaconic acid, monoalkyl itaconate, itaconic acid glycol monoether, citraconic acid, monoalkyl citraconate, and cinnamic acid; and metal salts of the foregoing monomers.

In the present specification, the term “acid (salt)” means acid or a salt of the acid. Moreover, the phrase “anhydride (salt) thereof” means anhydride thereof or anhydride salt thereof.

For example, a C3-C30 unsaturated monocarboxylic acid (salt) means a C3-C30 unsaturated monocarboxylic acid or a salt of a C3-C30 unsaturated monocarboxylic acid.

In the present specification, the term “(meth)acrylic acid” means methacrylic acid or acrylic acid.

In the present specification, the term “(meth)acryloyl” means methacryloyl or acryloyl.

In the present specification, the term “(meth)acrylate” means methacrylate or acrylate.

### (3) Sulfonic Acid Group-Containing Vinyl Monomer, Vinyl Sulfuric Acid Monoester Compound, and Salts of Sulfonic Acid Group-Containing Vinyl Monomer and Vinyl Sulfuric Acid Monoester Compound

Examples of the sulfonic acid group-containing vinyl monomer, the vinyl sulfuric acid monoester compound, and salts of the sulfonic acid group-containing vinyl monomer and vinyl sulfuric acid monoester compound include a C2-C14 alkene sulfonic acid (salt), a C2-C24 alkyl sulfonic acid (salt), sulfo(hydroxy)alkyl-(meth)acrylate (salt), sulfo(hydroxy)alkyl-(meth)acrylamide (salt), and alkylallylsulfosuccinic acid (salt).

Specific examples of the C2-C14 alkene sulfonic acid include vinyl sulfonic acid (salt). Specific examples of the C2-C24 alkyl sulfonic acid (salt) include α-methylstyrenesulfonic acid (salt). Specific examples of the sulfo(hydroxy)alkyl-(meth)acrylate (salt) and sulfo(hydroxy)alkyl-(meth)acrylamide (salt) include sulfopropyl(meth)acrylate (salt), a sulfuric acid ester (salt), and a sulfonic acid group-containing vinyl monomer (salt).

### (4) Phosphoric Acid Group-Containing Vinyl Monomer and Salts of Phosphoric Acid Group-Containing Vinyl Monomer

Examples of the phosphoric acid group-containing vinyl monomer and salts of the phosphoric acid group-containing vinyl monomer include a (meth)acryloyloxyalkyl (the number of carbon atoms: from 1 through 24) phosphoric acid monoester (salt), and (meth)acryloyloxyalkyl (the number of carbon atoms: from 1 through 24) phosphonic acid (salt).

Specific examples of the (meth)acryloyloxyalkyl (the number of carbon atoms: from 1 through 24)phosphoric acid monoester (salt) include 2-hydroxyethyl(meth)acryloyl phosphate (salt), and phenyl-2-acryloyloxyethyl phosphate (salt).

Specific examples of the (meth)acryloyloxyalkyl (the number of carbon atoms: from 1 through 24)phosphonic acid (salt) include 2-acryloyloxyethylphosphonic acid (salt).

Examples of salts of (2) to (4) above include alkali metal salts (e.g., sodium salt, and potassium salt), alkaline earth metal salts (e.g., calcium salt, and magnesium salt), ammonium salts, amine salts, and quaternary ammonium salts.

### (5) Hydroxyl Group-Containing Vinyl Monomer

Examples of the hydroxyl group-containing vinyl monomer include hydroxystyrene, N-methylol(meth)acrylamide, hydroxyethyl(meth)acrylate, hydroxypropyl(meth)acrylate, polyethylene glycol mono(meth)acrylate, (meth)allyl alcohol, crotyl alcohol, isocrotyl alcohol, 1-buten-3-ol, 2-buten-1-ol, 2-butane-1,4-diol, propargyl alcohol, 2-hydroxyethyl propenyl ether, and sucrose allyl ether.

### (6) Nitrogen-Containing Vinyl Monomer

Examples of the nitrogen-containing vinyl monomer include (6-1) an amino group-containing vinyl monomer, (6-2) an amide group-containing vinyl monomer, (6-3) a nitrile group-containing vinyl monomer, (6-4) a quaternary ammonium cation group-containing vinyl monomer, and (6-5) a nitro group-containing vinyl monomer.

Examples of the (6-1) amino group-containing vinyl monomer include aminoethyl (meth)acrylate.

Examples of the (6-2) amide group-containing vinyl monomer include (meth)acrylamide, and N-methyl(meth)acrylamide.

Examples of the (6-3) nitrile group-containing vinyl monomer include (meth)acrylonitrile, cyanostyrene, and cyanoacrylate.

Examples of the (6-4) quaternary ammonium cation group-containing vinyl monomer include quaternized compounds (compounds quaternized using a quaternizing agent, such as methyl chloride, dimethyl sulfate, benzyl chloride, and dimethyl carbonate) of a tertiary amine group-containing vinyl monomer [e.g., dimethylaminoethyl(meth)acrylate, diethylaminoethyl(meth)acrylate, dimethylaminoethyl(meth)acrylamide, diethylaminoethyl(meth)acrylamide, and diallylamine].

Examples of the (6-5) nitro group-containing vinyl monomer include nitrostyrene.

### (7) Epoxy Group-Containing Vinyl Monomer

Examples of the epoxy group-containing vinyl monomer include glycidyl (meth)acrylate, tetrahydrofurfuryl (meth)acrylate, and p-vinylphenyl phenyl oxide.

### (8) Halogen Element-Containing Vinyl Monomer

Examples of the halogen element-containing vinyl monomer include vinyl chloride, vinyl bromide, vinylidene chloride, allyl chloride, chlorostyrene, bromostyrene, dichlorostyrene, chloromethylstyrene, tetrafluorostyrene, and chloroprene.

### (9) Vinyl Ester, Vinyl (Thio)Ether, and Vinyl Ketone

Examples of the vinyl ester include vinyl acetate, vinyl butyrate, vinyl propionate, vinyl butyrate, diallyl phthalate, diallyl adipate, isopropenyl acetate, vinyl methacrylate, methyl 4-vinylbenzoate, cyclohexyl methacrylate, benzylmethacrylate, phenyl(meth)acrylate, vinyl methoxy acetate, vinyl benzoate, ethyl α-ethoxyacrylate, C1-C50 alkyl group-containing alkyl(meth)acrylate [e.g., methyl (meth)acrylate, ethyl (meth)acrylate, propyl (meth)acrylate, butyl (meth)acrylate, 2-ethylhexyl (meth)acrylate, dodecyl (meth)acrylate, hexadecyl (meth)acrylate, heptadecyl (meth)acrylate, octadecyl (meth)acrylate, eicosyl (meth)acrylate, and behenyl (meth)acrylate)], dialkyl fumarate (where 2 alkyl groups are each a C2-C8 straight-chain or branched-chain alicyclic group), dialkyl maleate (where 2 alkyl groups are each a C2-C8 straight-chain or branched-chain alicyclic group), poly(meth)allyloxy alkane (e.g., diallyloxy ethane, triallyloxy ethane, tetraallyloxy ethane, tetraallyloxy propane, tetraallyloxy butane, and tetrametha-allyloxy ethane), a polyalkylene glycol chain-containing vinyl monomer [e.g., polyethylene glycol (molecular weight: 300) mono(meth)acrylate, polypropylene glycol (molecular weight: 500) monoacrylate, (meth)acrylate of a methyl alcohol ethylene oxide (10 mol) adduct, and (meth)acrylate of a lauryl alcohol ethylene oxide (30 mol) adduct], and poly(meth)acrylate [e.g., poly(meth)acrylate of multivalent alcohol:ethylene glycol di(meth)acrylate, propylene glycol di(meth)acrylate, neopentyl glycol di(meth)acrylate, trimethylolpropane tri(meth)acrylate, and polyethylene glycol di(meth)acrylate].

Examples of the vinyl (thio)ether include vinyl methyl ether.

Examples of the vinyl ketone include methyl vinyl ketone.

### (10) Other Vinyl Monomers

Examples of other vinyl monomers include tetrafluoroethylene, fluoroacrylate, isocyanatoethyl (meth)acrylate, and m-isopropenyl-α,α-dimethylbenzyl isocyanate.

The above-listed vinyl monomers (1) to (10) may be used alone or in combination for synthesis of the resin (b1).

Considering low-temperature fixability, the resin (b1) is preferably a styrene-(meth)acrylic acid ester copolymer or a (meth)acrylic acid ester copolymer, and more preferably a styrene-(meth)acrylic acid ester copolymer.

Since the resin (b1) includes carboxylic acid, the resin (b1) imparts an appropriate acid value to the resin constituting each resin particle (B). Therefore, toner particles where the resin particles (B) are deposited on a surface of each of toner base particles are easily formed.

Examples of a vinyl monomer used for the resin (b2) include the vinyl monomers listed for the resin (b1).

The vinyl monomers (1) to (10) listed for the resin (b1) may be used alone or in combination for synthesis of the resin (b2).

Considering low-temperature fixability, the resin (b2) is preferably a styrene-(meth)acrylic acid ester copolymer or a (meth)acrylic acid ester copolymer, and more preferably a styrene-(meth)acrylic acid ester copolymer.

A viscoelastic loss modulus G″ of the resin (b1) at 100° C. with the frequency of 1 Hz is preferably from 1.5 MPa through 100 MPa, more preferably from 1.7 MPa through 30 MPa, and even more preferably from 2.0 MPa through 10 MPa.

A viscoelastic loss modulus G″ of the resin (b2) at 100° C. with the frequency of 1 Hz is preferably from 0.01 MPa through 1.0 MPa, more preferably from 0.02 MPa through 0.5 MPa, and even more preferably from 0.05 MPa through 0.3 MPa.

When the viscoelastic loss modulus G″ is within the above-mentioned ranges, toner particles, where resin particles (B) each including the resin (b1) and the resin (b2) as constituent materials are deposited on a surface of each of the toner base particles, are easily formed.

The viscoelastic loss moduli G″ of the resins (b1) and (b2) at 100° C. with frequency of 1 Hz can be adjusted by varying constituent monomers used and/or a blending ratio thereof, or adjusting polymerization conditions (e.g., an initiator for use and an amount thereof, a chain-transfer agent for use and an amount thereof, and a reaction temperature).

Specifically, for example, G″ of each resin can be adjusted to the above-mentioned range by adjusting the resin to satisfy the following conditions.

(1) Tg1 is preferably from 0° C. through 150° C., more preferably from 50° C. through 100° C., where Tg1 is a glass transition temperature calculated from the constituent monomers of the resin (b1). Tg2 is preferably from −30° C. through 100° C., more preferably from 0° C. through 80° C., and even more preferably from 30° C. through 60° C., where Tg2 is a glass transition temperature calculated from the constituent monomers of the resin (b2).

The glass transition temperature (Tg) calculated from the constituent monomers is a value calculated according to the Fox method.

The Fox method [T. G. Fox, Phys. Rev., 86, 652(1952)] is a method of estimating Tg of a copolymer from Tg of each homopolymer as represented by the following formula.

1/Tg=W1/Tg1+W2/Tg2+ . . . +Wn/Tgn

In the formula above, Tg is a glass transition temperature (absolute temperature) of a copolymer, Tg1, Tg2 . . . Tgn are each a glass transition temperature (absolute temperature) of a homopolymer of each constituent monomer, and W1, W2 . . . Wn are each a weight fraction of each constituent monomer.

(2) (AV1) is preferably from 75 mgKOH/g through 400 mgKOH/g, and more preferably from 150 mgKOH/g through 300 mgKOH/g, where (AV1) is a calculated acid value of the resin (b1). Moreover, (AV2) is preferably from 0 mgKOH/g through 50 mgKOH/g, more preferably from 0 mgKOH/g through 20 mgKOH/g, and even more preferably 0 mgKOH/g, where (AV2) is a calculated acid value of the resin (b2).

The calculated acid value is a theoretical acid value calculated from a molar amount of an acid group included in a constituent monomer, and a total weight of the constituent monomer.

As constituent monomers satisfying the conditions of (1) and (2), for example, the resin (b1) is a resin including, as constituent monomers, styrene preferably in an amount of from 10% by weight through 80% by weight, and more preferably from 30% by weight through 60% by weight, and methacrylic acid and/or acrylic acid preferably in the combined amount of from 10% by weight through 60% by weight, and more preferably from 30% by weight through 50% by weight, relative to a total mass of the resin (b1).

As constituent monomers satisfying the conditions of (1) and (2), moreover, the resin (b2) is, for example, a resin including, as constituent monomers, styrene preferably in an amount of from 10% by mass through 100% by mass, and more preferably from 30% by mass through 90% by mass, and methacrylic acid and/or acrylic acid preferably in the combined amount of from 0% by mass through 7.5% by mass, and more preferably from 0% by mass through 2.5% by mass, relative to a total mass of the resin (b2).

(3) Polymerization conditions (e.g., an initiator for use and an amount thereof, a chain-transfer agent for use and an amount thereof, and a reaction temperature) are adjusted. Specifically, the number average molecular weight (Mn1) of the resin (b1) is preferably from 2,000 through 2,000,000, and more preferably 20,000 through 200,000, and the number average molecular weight (Mn2) of the resin (b2) is preferably from 1,000 through 1,000,000, and more preferably from 10,000 through 100,000.

In the present disclosure, the viscoelastic loss modulus G″ is measured, for example, by means of the following rheometer.

Device: ARES-24A (available from Rheometric Scientific)
Jig: 25 mm parallel plate

### Frequency: 1 Hz

Distortion factor: 10%
Heating speed: 5° C./min

The acid value (AVb1) of the resin (b1) is preferably from 75 mgKOH/g through 400 mgKOH/g, and more preferably from 150 mgKOH/g through 300 mgKOH/g.

When the acid value (AVb1) of the resin (b1) is within the above-mentioned ranges, toner particles, where resin particles (B) each including a vinyl unit that includes, as constituent segments, a segment derived from the resin (b1) and a segment derived from the resin (b2) in a molecular chain thereof are deposited on a surface of each of toner base particles, are easily formed.

The resin (b1) having the acid value in the above-mentioned ranges is a resin including methacrylic acid and/or acrylic acid preferably in the combined amount of from 10% by mass through 60% by mass, and more preferably from 30% by mass through 50% by mass, relative to a total weight of the resin (b1).

The acid value (AVb2) of the resin (b2) is preferably from 0 mgKOH/g through 50 mgKOH/g, more preferably from 0 mgKOH/g through 20 mgKOH/g, and even more preferably 0 mgKOH/g, considering low-temperature fixability.

The resin (b2) having the acid value (Avb2) in the above-mentioned ranges is a resin including methacrylic acid and/or acrylic acid preferably in the combined amount of from 0% by mass through 7.5% by mass, and more preferably from 0% by mass through 2.5% by mass, relative to a total weight of the resin (b2).

For example, the acid value can be measured according to the method specified in JIS K0070:1992.

The glass transition temperature of the resin (b1) is preferably higher than the glass transition temperature of the resin (b2), more preferably higher by 10° C. or greater, and even more preferably higher by 20° C. or greater.

When the glass transition temperature of the resin (b1) is within the above-mentioned ranges, an excellent balance between easiness of formation of toner particles and low-temperature fixability of the toner particles can be achieved, where the toner particles are each a particle in which the resin particles (B) are deposited on a surface of a toner base particle.

The glass transition temperature (may be abbreviated as Tg hereinafter) of the resin (b1) is preferably 0° C. or higher and 150° C. or lower, and more preferably from 50° C. or higher and 100° C. or lower.

When the glass transition temperature of the resin (b1) is 0° C. or higher, heat-resistant storage stability of a resulting toner improves. When the glass transition temperature of the resin (b1) is 150° C. or lower, the resin (b1) does not adversely affect low-temperature fixability of a resulting toner.

Tg of the resin (b2) is preferably −30° C. or higher and 100° C. or lower, more preferably 0° C. or higher and 80° C. or lower, and even more preferably 30° C. or higher and 60° C. or lower. When the glass transition temperature of the resin (b2) is −30° C. or higher, heat-resistant storage stability of a resulting toner improves. When the glass transition temperature of the resin (b2) is 100° C. or lower, the resin (b2) does not adversely affect low-temperature fixability of a resulting toner.

In the present disclosure, Tg is measured by means of DSC20, SSC/580 (available from Seiko Instruments Inc.) according to the method (e.g., DSC) specified in ASTM D3418-82.

A solubility parameter (may be abbreviated as “SP” hereinafter) value of the resin (b1) is preferably 9 (cal/cm³)^{1/2} or greater and 13 (cal/cm³)^{1/2} or less, more preferably 9.5 (cal/cm³)^{1/2} or greater and 12.5 (cal/cm³)^{1/2} or less, and even more preferably 10.5 (cal/cm³)^{1/2} or greater and 11.5 (cal/cm³)^{1/2} or less, considering easiness of formation of toner particles.

The SP value of the resin (b1) can be adjusted by changing monomers for constituting the resin (b1) and a composition ratio of the monomers constituting the resin (b1).

The SP value of the resin (b2) is preferably 8.5 (cal/cm³)^{1/2} or greater and 12.5 (cal/cm³)^{1/2} or less, more preferably 9 (cal/cm³)^{1/2} or greater and 12 (cal/cm³)^{1/2} or less, and even more preferably 10 (cal/cm³)^{1/2} or greater and 11 (cal/cm³)^{1/2} or less, considering easiness of formation of toner particles.

The SP value of the resin (b2) can be adjusted by changing monomers for constituting the resin (b2) and a composition ratio of the monomers constituting the resin (b2).

In the present disclosure, the SP value can be calculated by the method proposed by Fedors [Polym. Eng. Sci. 14(2)152, (1974)].

Considering Tg of the resin (b1) and copolymerizability with other monomers, an amount of styrene as a constituent monomer of the resin (b1) is preferably 10% by mass or greater and 80% by mass or less, and more preferably 30% by mass or greater and 60% by mass or less relative to a total mass of the resin (b1).

Considering Tg of the resin (b2) and copolymerizability with other monomers, an amount of styrene as a constituent monomer of the resin (b2) is preferably 10% by mass or greater and 100% by mass or less, and more preferably 30% by mass or greater and 90% by mass or less relative to a total mass of the resin (b2).

The number average molecular weight (Mn) of the resin (b1) is preferably from 2,000 through 2,000,000, and more preferably from 20,000 through 200,000. When the number average molecular weight (Mn) of the resin (b1) is 2,000 or greater, heat-resistant storage stability of a resulting toner improves. When the number average molecular weight (Mn) of the resin (b1) is 2,000,000 or less, the resin (b1) does not adversely affect low-temperature fixability of a resulting toner.

The weight average molecular weight (Mw) of the resin (b1) is preferably greater than the weight average molecular weight of the resin (b2), more preferably greater than the weight average molecular weight of the resin (b2) by 1.5 times or greater, and further more preferably greater than the weight average molecular weight of the resin (b2) by 2.0 times or greater. When the weight average molecular weight (Mw) of the resin (b1) is within the above-listed ranges, an excellent balance between easiness of formation of toner particles and low-temperature fixability is achieved.

The weight average molecular weight (Mw) of the resin (b1) is preferably from 20,000 through 20,000,000, and more preferably from 200,000 through 2,000,000. When the weight average molecular weight of the resin (b1) is 20,000 or greater, heat-resistant storage stability of a resulting toner improves. When the weight average molecular weight (Mw) of the resin (b1) is 20,000,000 or less, the resin (b1) does not adversely affect low-temperature fixability of a resulting toner.

The number average molecular weight (Mn) of the resin (b2) is preferably from 1,000 through 1,000,000, and more preferably from 10,000 through 100,000. When Mn of the resin (b2) is 1,000 or greater, heat-resistant storage stability of a resulting toner improves. When Mn of the resin (b2) is 1,000,000 or less, the resin (b2) does not adversely affect low-temperature fixability of a resulting toner.

The weight average molecular weight (Mw) of the resin (b2) is preferably from 10,000 through 10,000,000, and more preferably from 100,000 through 1,000,000. When Mw of the resin (b2) is 10,000 or greater, heat-resistant storage stability of a resulting toner improves. When Mw of the resin (b2) is 10,000,000 or less, the resin (b2) does not adversely affect low-temperature fixability of a resulting toner.

Among the above-listed examples, Mw of the resin (b1) is preferably from 200,000 through 2,000,000, Mw of the resin (b2) is preferably from 100,000 through 500,000, and Mw of the resin (b1) and Mw of the resin (b2) satisfy the relation represented by [Mw of Resin (b1)]>[Mw of Resin (b2)].

In the present disclosure, Mn and Mw can be determined by gel permeation chromatography (GPC) under the following conditions.

Device (one example): HLC-8120, available from Tosoh Corporation
Columns (one example): 2 columns, TSK GEL GMH6, available from Tosoh Corporation
Measuring temperature: 40° C.
Sample solution: 0.25% by mass tetrahydrofuran solution (from which an insoluble component is separated by filtration with a glass filter)
Solution injection amount: 100 μL
Detection device: refractive index detector
Reference materials: 12 samples of standard polystyrene (TSKstandard POLYSTYRENE) (molecular weights: 500, 1,050, 2,800, 5,970, 9,100, 18,100, 37,900, 96,400, 190,000, 355,000, 1,090,000, and 2,890,000) [available from Tosoh Corporation]

A mass ratio of the resin (b1) to the resin (b2) in the resin particles (B) is preferably from 5/95 through 95/5, more preferably from 25/75 through 75/25, and even more preferably from 40/60 through 60/40. When the mass ratio of the resin (b1) to the resin (b2) is 5/95 or greater, a resulting toner has excellent heat-resistant storage stability. When the mass ratio of the resin (b1) to the resin (b2) is 95/5 or less, toner particles where the resin particles (B) are deposited on a surface of each of toner base particles are easily formed.

Examples of a method of producing the resin particles (B) include production methods known in the art. Examples thereof include the following production methods (I) to (V):

(I) a method where monomers for constituting the resin (b2) are polymerized through seeded polymerization using particles of the resin (b1) in the aqueous dispersion liquid as seeds;
(II) a method where monomers for constituting the resin (b1) are polymerized through seeded polymerization using particles of the resin (b2) in the aqueous dispersion liquid as seeds;
(III) a method where a mixture of the resin (b1) and the resin (b2) is emulsified in an aqueous medium to obtain a resin particle aqueous dispersion liquid;
(IV) a method where a mixture of the resin (b1) and constituent monomers of the resin (b2) is emulsified in an aqueous medium, followed by polymerizing the constituent monomers of the resin (b2) to obtain a resin particle aqueous dispersion liquid; and
(V) a method where the resin (b2) and constituent monomers of the resin (b1) are emulsified in an aqueous medium, followed by polymerizing the constituent monomers of the resin (b1) to obtain a resin particle aqueous dispersion liquid.

Whether the resin particles (B) include the shell resin (b1) and the core resin (b2) as constituent materials in each particle can be confirmed by observing an element mapping image of a cross-sectional surface of the resin particle (B) by means of a known surface elemental analysis device (e.g., TOF-SIMSEDX-SEM), or observing cross-sectional surfaces of the resin particles (B) dyed with a dye suited for functional groups included in the resin (b1) and the resin (b2) under an electron microscope.

The resin particles obtained by the above-described method may be a mixture of resin particles each including only the resin (b1) as a constituent resin, and of resin particles each including only the resin (b2) as a constituent resin, in addition to the resin particles (B) each including, as constituent materials, the resin (b1) and the resin (b2). In the below-mentioned composite particle formation, the above mixture of resin particles may be used, or only the resin particles (B) may be isolated and used.

Specific examples of (I) include: a method where constituent monomers of the resin (b1) are dripped and polymerized to produce an aqueous dispersion liquid of resin particles including the resin (b1), followed by polymerizing constituent monomers of the resin (b2) through seeded polymerization using the resin particles including the resin (b1) as seeds; and a method where the resin (b1), which is produced in advance by solution polymerization etc., is emulsified and dispersed in water, followed by polymerizing constituent monomers of the resin (b2) through seeded polymerization using the resin (b1) as seeds.

Specific examples of (II) include: a method where constituent monomers of the resin (b2) are dripped and polymerized to produce an aqueous dispersion liquid of resin particles including the resin (b2), followed by polymerizing constituent monomers of the resin (b1) through seeded polymerization using the resin particles including the resin (b2) as seeds; and a method where the resin (b2), which is produced in advance by solution polymerization etc., is emulsified and dispersed in water, followed by polymerizing constituent monomers of the resin (b1) through seeded polymerization using the resin (b2) as seeds.

Specific examples of (III) include a method where a solution or melt of the resin (b1) and a solution or melt of the resin (b2), which are produced in advance by solution polymerization etc., are mixed together, followed by emulsifying and dispersing the resulting mixture into an aqueous medium.

Specific examples of (IV) include: a method where the resin (b1), which is produced in advance by solution polymerization etc., and constituent monomers of the resin (b2) are mixed, and the resulting mixture is emulsified and dispersed in an aqueous medium, followed by polymerizing the constituent monomers of the resin (b2); and a method where the resin (b1) is produced in constituent monomers of the resin (b2), and the resulting mixture is emulsified and dispersed in an aqueous medium, followed by polymerizing the constituent monomers of the resin (b2).

Specific examples of (V) include: a method where the resin (b2), which is produced in advance by solution polymerization etc., is mixed with constituent monomers of the resin (b1), and the resulting mixture is emulsified and dispersed in an aqueous medium, followed by polymerizing the constituent monomers of the resin (b1); and a method where the resin (b2) is produced in constituent monomers of the resin (b1), and the resulting mixture is emulsified and dispersed in an aqueous medium, followed by polymerizing the constituent monomers of the resin (b1).

In the present disclosure, any of the production methods (I) to (V) is suitably used.

The resin particles (B) are preferably used in the form of an aqueous dispersion liquid.

Materials used for the aqueous dispersion liquid (e.g., an aqueous medium) are not particularly limited, provided that the materials are soluble to water. The materials may be appropriately selected in accordance with the intended purpose. Examples of the materials include a surfactant (D), a buffer, and a protective colloid. The above-listed examples may be used alone or in combination.

The aqueous medium used for the aqueous dispersion liquid is not particularly limited, provided that the aqueous medium is a fluid including water as an essential constituent material. Examples of the aqueous medium include a solution including water.

Examples of the surfactant (D) include a nonionic surfactant (D1), an anionic surfactant (D2), a cationic surfactant (D3), an amphoteric surfactant (D4), and any other emulsification dispersing agent (D5).

Examples of the nonionic surfactant (D1) include an alkylene oxide (AO) adduct-based nonionic surfactant, and a multivalent alcohol-based nonionic surfactant.

Examples of the AO adduct-based nonionic surfactant include an ethylene oxide (EO) adduct of C10-C20 aliphatic alcohol, an EO adduct of phenol, an EO adduct of nonyl phenol, an EO adduct of C8-C22 alkylamine, and an EO adduct of poly(oxypropylene)glycol.

Examples of the multivalent alcohol-based nonionic surfactant include: a C8-C24 fatty acid ester of multivalent (trivalent to octavalent, or higher) C2-C30 alcohol (e.g., glycerin monostearate, glycerin monooleate, sorbitan monolaurate, and sorbitan monooleate); and a C4-C24 alkyl glycoside (degree of polymerization: from 1 through 10).

Examples of the anionic surfactant (D2) include: a C8-C24 hydrocarbon group-containing ether carboxylic acid, and salts thereof; a C8-C24 hydrocarbon group-containing sulfuric acid ester or ether sulfuric acid ester, and salts thereof; a C8-C24 hydrocarbon group-containing sulfonic acid salt; a sulfosuccinic acid salt including one or two C8-C24 hydrocarbon groups; a C8-C24 hydrocarbon group-containing phosphoric acid ester or ether phosphoric acid ester, and salts thereof; a C8-C24 hydrocarbon group-containing fatty acid salt; and a C8-C24 hydrocarbon group-containing acylated amino acid salt.

Examples of the C8-C24 hydrocarbon group-containing ether carboxylic acid and salts thereof include sodium lauryl ether acetate, and sodium (poly)oxyethylene (the number of moles added: from 1 through 100) lauryl ether acetate.

Examples of the C8-C24 hydrocarbon group-containing sulfuric acid ester or ether sulfuric acid ester and salts thereof include sodium lauryl sulfate, sodium (poly)oxyethylene (the number of moles added: from 1 through 100) lauryl sulfate, triethanolamine (poly)oxyethylene (the number of moles added: from 1 through 100) lauryl sulfate, and (poly)oxyethylene (the number of moles added: from 1 through 100) coconut fatty acid monoethanolamide sodium sulfate.

Examples of the C8-C24 hydrocarbon group-containing sulfonic acid salt include sodium dodecylbenzene sulfonate.

Examples of the C8-C24 hydrocarbon group-containing phosphoric acid ester or ether phosphoric acid ester and salts thereof include sodium lauryl phosphate, and sodium (poly)oxyethylene (the number of moles added: from 1 through 100) lauryl ether phosphate.

Examples of the C8-C24 hydrocarbon group-containing fatty acid salt include sodium laurate, and triethanolamine laurate.

Examples of the C8-C24 hydrocarbon group-containing acylated amino acid salt include sodium methyl cocoyl taurate, sodium cocoyl sarcosinate, triethanolamine cocoyl sarcosinate, triethanolamine N-cocoyl-L-glutamate, sodium N-cocoyl-L-glutamate, and a laurylmethyl-β-alanine sodium salt.

Examples of the cationic surfactant (D3) include a quaternary ammonium salt-based cationic surfactant, and an amine salt-based cationic surfactant.

Examples of the quaternary ammonium salt-based cationic surfactant include trimethyl stearyl ammonium chloride, behenyl trimethyl ammonium chloride, distearyl dimethyl ammonium chloride, and N—(N′-lanolin fatty acid amide propyl) N-ethyl-N,N-dimethyl ammonium ethyl sulfate (i.e. Quaterinium-33).

Examples of the amine salt-based cationic surfactant include stearic acid diethylaminoethylamide lactic acid salt, dilaurylamine hydrochloride, and oleylamine lactate.

Examples of the amphoteric surfactant (D4) include a betaine-based amphoteric surfactant, and an amino acid-based amphoteric surfactant.

Examples of the betaine-based amphoteric surfactant include coconut oil fatty acid amidepropyldimethylaminoacetic acid betaine, lauryl dimethylaminoacetic acid betaine, 2-alkyl-N-carboxymethyl-N-hydroxyethylimidazolium betaine, and lauryl hydroxysulfobetaine.

Examples of the amino acid-based amphoteric surfactant include sodium β-laurylaminopropionate.

Examples of other emulsification dispersing agents (D5) include a reaction active agent.

The reaction active agent is not particularly limited, provided that the reaction active agent has radical reactivity. The reaction active agent may be appropriately selected in accordance with the intended purpose. Examples of the reaction active agent include: ADEKA REASOAP (registered trademark) SE-10N, SR-10, SR-20, SR-30, ER-20, and ER-30 (all available from ADEKA CORPORATION); HS-10, KH-05, KH-10, and KH-1025 (all available from DKS Co., Ltd.); ELEMINOL (registered trademark) JS-20 (available from SANYO CHEMICAL, LTD.); LATEMUL (registered trademark) D-104, PD-420, and PD-430 (available from Kao Corporation); IONET (registered trademark) MO-200 (available from SANYO CHEMICAL, LTD.); polyvinyl alcohol; starch and derivatives thereof; cellulose derivatives, such as carboxymethyl cellulose, methyl cellulose, and hydroxyethyl cellulose; carboxyl group-containing (co)polymer, such as polyacrylic acid soda; and urethane group or ester group-containing emulsification dispersing agents (e.g., a compound obtained by linking polycaptolactone polyol and polyether diol with polyisocyanate) disclosed in U.S. Pat. No. 5,906,704.

The surfactant (D) is preferably (D1), (D2), (D5), or any combination thereof, and more preferably a combination of (D1) and (D5), or a combination of (D2) and (D5) for stabilizing oil droplets to obtain desired particle shapes and a sharp particle size distribution during emulsification and dispersion.

Examples of the buffer include sodium acetate, sodium citrate, and sodium bicarbonate.

Examples of the protective colloid include a water-soluble cellulose compound, and an alkali metal salt of polymethacrylic acid.

In addition to the shell resin (b1) and the core resin (b2), the resin particle (B) may further include other constituent resins, an initiator (and a residue thereof), a chain-transfer agent, an antioxidant, a plasticizer, a preservative, a reducing agent, and an organic solvent.

Examples of the above-mentioned other constituent resins include a vinyl resin excluding the vinyl resin used for the resin (b1) and the resin (b2), a polyurethane resin, an epoxy resin, a polyester resin, a polyamide resin, a polyimide resin, a silicon-based resin, a phenol resin, a melamine resin, a urea resin, an aniline resin, an ionomer resin, and a polycarbonate resin.

Examples of the initiator (and a residue thereof) include radical polymerization initiators known in the art. Specific examples thereof include: a persulfuric acid salt initiator, such as potassium persulfate, and ammonium persulfate; an azo initiator, such as azobisisobutyronitrile; organic peroxide, such as benzoyl peroxide, cumene hydroperoxide, tert-butyl hydroperoxide, tert-butyl peroxyisopropyl monocarbonate, and tert-butyl peroxybenzoate; and hydrogen peroxide.

Examples of the chain-transfer agent include n-dodecylmercaptan, tert-dodecylmercaptan, n-butylmercaptan, 2-ethylhexyl thioglycolate, 2-mercaptoethanol, β-mercaptopropionic acid, and α-methylstyrene dimer.

Examples of the antioxidant include a phenol compound, para-phenylenediamine, hydroquinone, an organic sulfur compound, and an organophosphorus compound.

Examples of the phenol compound include 2,6-di-t-butyl-p-cresol, butylated hydroxyanisole, 2,6-di-t-butyl-4-ethylphenol, stearyl-R-(3,5-di-t-butyl-4-hydroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris-(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, and tocopherol.

Examples of the para-phenylenediamine include N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, and N,N′-dimethyl-N,N′-di-t-butyl-p-phenylenediamine.

Examples of the hydroquinone include 2,5-di-t-octylhydroquinone, 2,6-didodecylhydroquinone, 2-dodecylhydroquinone, 2-dodecyl-5-chlorohydroquinone, 2-t-octyl-5-methylhydroquinone, and 2-(2-octadecenyl)-5-methylhydroquinone.

Examples of the organic sulfur compound include dilauryl-3,3′-thiodipropionate, distearyl-3,3′-thiodipropionate, and ditetradecyl-3,3′-thiodipropionate.

Examples of the organophosphorus compound include triphenylphosphine, tri(nonylphenyl)phosphine, tri(dinonylphenyl)phosphine, tricresyl phosphate, and tri(2,4-dibutylphenoxy)phosphine.

Examples of the plasticizer include a phthalic acid ester, aliphatic diprotic acid ester, trimellitic acid ester, phosphoric acid ester, and fatty acid ester.

Examples of the phthalic acid ester include dibutyl phthalate, dioctyl phthalate, butylbenzyl phthalate, and isodecyl phthalate.

Examples of the aliphatic diprotic acid ester include di-2-ethylhexyl adipate, and 2-ethylhexyl sebacate.

Examples of the trimellitic acid ester include tri-2-ethylhexyl trimellitate, and trioctyl trimellitate.

Examples of the phosphoric acid ester include triethyl phosphate, tri-2-ethylhexyl phosphate, and tricresyl phosphate.

Examples of the fatty acid ester include butyl oleate.

Examples of the preservative include an organic nitrogen sulfur compound preservative, and an organic sulfur halogenated compound preservative.

Examples of the reducing agent include: a reducing organic compound, such as ascorbic acid, tartaric acid, citric acid, glucose, and formaldehyde sulfoxylate metal salt; and a reducing inorganic compound, such as sodium thio sulfate, sodium sulfite, sodium bisulfite, and sodium metabisulfite.

Examples of the organic solvent include: a ketone solvent, such as acetone, and methyl ethyl ketone (may be abbreviated as MEK hereinafter); an ester solvent, such as ethyl acetate, and γ-butyrolactone; an ether solvent, such as tetrahydrofuran (THF); an amide solvent, such as N,N-dimethylformamide, N,N-dimethylacetamide, N-methyl-2-pyrrolidone, and N-methylcaprolactam; an alcohol solvent, such as isopropyl alcohol; and an aromatic hydrocarbon solvent, such as toluene, and xylene.

An amount of the resin particles relative to the toner is preferably from 0.2% by mass through 5% by mass. When a sum of the amount of the resin (b1) and the amount of the resin (b2) is within the above-mentioned range, low-temperature fixability and heat-resistant storage stability of a resulting toner improve. When the amount of the resin particles relative to the toner is 0.2% by mass or greater, a problem, such as poor heat-resistant storage stability, can be prevented. When the amount of the resin particles relative to the toner is 5% by mass or less, a problem, such as poor low-temperature fixability, can be prevented.

### <External Additive>

The external additive includes particles, where the particles include primary particles and cohesive particles. The particles of the external additive may include only the cohesive particles without including the primary particles.

### —Coalescence Particles—

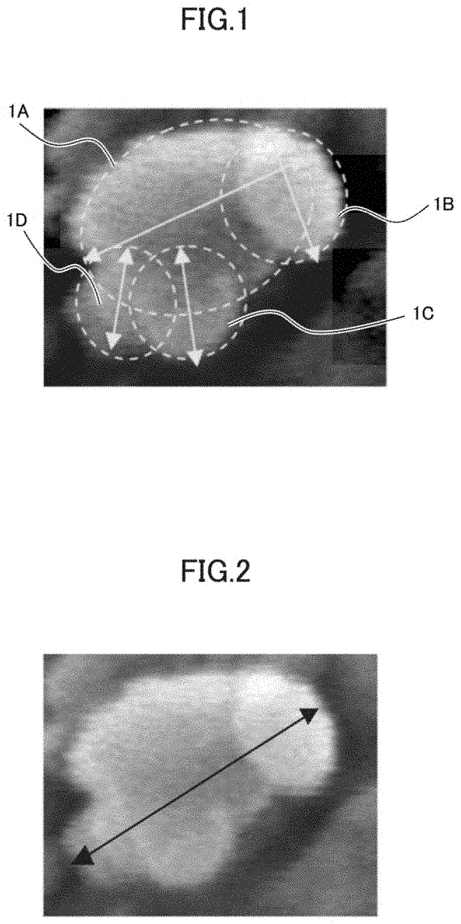

The cohesive particles are each a non-spherical particle including primary particles that are cohered. Specifically, the cohesive particles are secondary particles in each of which primary particles 1A to 1D are combined (aggregated) together as illustrated in FIG. 1. In the present specification, the “cohesive particle(s)” may be referred to as “secondary particle(s).”

### ——Primary Particles——

The primary particles are not particularly limited, and may be appropriately selected in accordance with the intended purpose. Examples of the primary particles include: inorganic particles, such as particles of silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride; and organic particles. The above-listed examples may be used alone or in combination. Among the above-listed examples, silica is preferable.

### ——Secondary Particles——

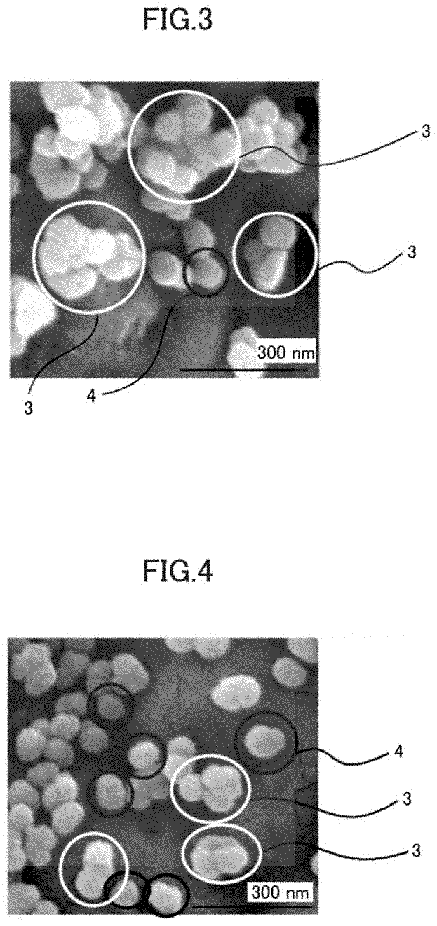

The secondary particles are not particularly limited, and may be appropriately selected in accordance with the intended purpose. Like the particles indicated with the numerical reference 3 in FIGS. 3 and 4, the secondary particles are preferably particles in each of which the primary particles are chemically bonded using a below-described treating agent, i.e., secondary aggregated particles, and more preferably particles in each of which the primary particles are chemically bonded according to a sol-gel method. Specific examples of the secondary particles include sol-gel silica.

The volume average particle diameter of the secondary particles, i.e., the volume average particle diameter of the cohesive particles, is not particularly limited, and may be appropriately selected in accordance with the intended purpose. The volume average particle diameter of the secondary particles is preferably 15 nm or greater and 400 nm or less, and more preferably 50 nm or greater and 300 nm or less. When the volume average particle diameter of the secondary particles is less than 15 nm, the external additive tends to be embedded in the toner base particle and a resulting toner cannot maintain adequate durability, consequently causing inadequate cleaning properties of the toner. When the volume average particle diameter of the secondary particles is greater than 400 nm, the external additive may not be desirably deposited on the toner base particles, and the external additive is easily detached from the toner base particles. Therefore, transfer properties of a resulting toner may not be maintained.

The volume average particle diameter of the secondary particles can be measured by dispersing the secondary particles in a suitable solvent (e.g., THF), followed by removing the solvent on a substrate to dry and solidify to prepare a sample of the secondary particles, and measuring particle diameters of the secondary particles in field of view under a field emission scanning electron microscope (FE-SEM, acceleration voltage: from 5 kV through 8 kV, magnifications: 8,000× to 10,000×). Specifically, the volume average particle diameter of the secondary particles is measured by estimating a whole image of each particle from an outline of each secondary particle formed of cohered primary particles, and measuring the maximum length (i.e., the length indicated with the arrow in FIG. 2) of the whole image (the number of particles to be measured: 100 particles or more).

### —Production Method of Cohesive Particles—

A production method of the cohesive particles is not particularly limited, and may be appropriately selected in accordance with the intended purpose. The production method is preferably a production method in accordance with a sol-gel method, specifically, a method where primary particles and a treating agent are mixed and fired to chemically bond the primary particles to cause secondary aggregations of the primary particles, to thereby form secondary particles (i.e., cohesive particles). When the cohesive particles are formed by the sol-gel method, primary particles may be synthesized in the presence of the treating agent to prepare cohesive particles in a single step reaction. An example of the production example will be described hereinafter, but the production example is not limited to the example described below.

### ——Treating Agent——

The treating agent is not particularly limited, and may be appropriately selected in accordance with the intended purpose. Examples of the treating agent include a silane-based treating agent, and an epoxy-based treating agent. The above-listed examples may be used alone or in combination. When silica is used as the primary particles, the treating agent is preferably a silane-based treating agent because a Si—O—Si bond formed by the silane-based treating agent is more stable to heat than a Si—O—C bond formed by the epoxy-based treating agent. Moreover, a treatment aid (e.g., water, and a 1% by mass acetic acid aqueous solution) may be optionally used.

### ———Silane-Based Treating Agent———

The silane-based treating agent is not particularly limited, and may be appropriately selected in accordance with the intended purpose. Examples of the silane-based treating agent include alkoxysilanes (e.g., tetramethoxysilane, tetraethoxysilane, methyltrimethoxysilane, methyltriethoxysilane, dimethyldimethoxysilane, dimethyldiethoxysilane, methyldimethoxysilane, methyldiethoxysilane, diphenyldimethoxysilane, isobutyltrimethoxysilane, and decyltrimethoxysilane); a silane coupling agent (e.g., γ-aminopropyltriethoxysilane, γ-glycidoxypropyltrimethoxysilane, γ-glycidoxypropylmethyldiethoxysilane, γ-methacryloxypropyltrimethoxysilane, γ-mercaptopropyltrimethoxysilane, vinyl triethoxysilane, and methyl vinyl dimethoxysilane); and a mixture including any of vinyl trichlorosilane, dimethyldichlorosilane, methyl vinyl dichlorosilane, methylphenyldichlorosilane, phenyltrichlorosilane, N,N′-bis(trimethylsilyl)urea, N,O-bis (trimethylsilyl)acetamide, dimethyltrimethylsilylamine, hexamethyldisilazane, and cyclic silazane.

The silane-based treating agent facilitates chemical bonding between primary particles (e.g., silica primary particles) to cause secondary aggregations in the following manner.

When the silica primary particles are treated using the alkoxy silane or the silane coupling agent as the silane-based treating agent, a silanol group of the silica primary particle and an alkoxy group of the silane-based treating agent are reacted through a dealcoholization reaction to newly form a Si—O—Si bond to cause a secondary aggregation, as presented in Formula (A).

When the silica primary particles are treated using the chlorosilane as the silane-based treating agent, a chloro group of the chlorosilane and a silanol group of the silica primary particle are reacted through a dehydrochlorination reaction. As a result, a Si—O—Si bond is newly formed due to a dehydration reaction to cause a secondary aggregation. When the silica primary particles are treated using the chlorosilane as the silane-based treating agent, first, the chlorosilane and water cause hydrolysis to form a silanol group, if water is present in a system, and the silanol group formed by the hydrolysis and a silanol group of the silica primary particle are reacted through a dehydration reaction to newly form a Si—O—Si bond to cause a secondary aggregation.

When the silica primary particles are treated using the silazane as the silane-based treating agent, an amino group of the silazane and a silanol group of the silica primary particle are reacted through deammonification to newly form a Si—O—Si bond to cause a secondary aggregation.

—Si—OH+RO—Si—→—Si—O—Si—+ROH Formula (A)

In Formula (A), R is an alkyl group.

### ———Epoxy-Based Treating Agent———

The epoxy-based treating agent is not particularly limited, and may be appropriately selected in accordance with the intended purpose. Examples of the epoxy-based treating agent include a bisphenol A epoxy resin, a bisphenol F epoxy resin, a phenol novolac epoxy resin, a cresol novolac epoxy resin, a bisphenol A novolac epoxy resin, a bisphenol epoxy resin, a glycidyl amine epoxy resin, and an alicyclic epoxy resin.

The epoxy-based treating agent facilitates chemical bonding between the primary particles (e.g., silica primary particles) to cause secondary aggregations, as presented in Formula (B) below. When the silica primary particles are treated using the epoxy-based treating agent, a silanol group of the silica primary particle is reacted with and added to an oxygen atom in an epoxy group or a carbon atom bonded to the epoxy group of the epoxy-based treating agent to newly form a Si—O—C bond to cause secondary aggregations.

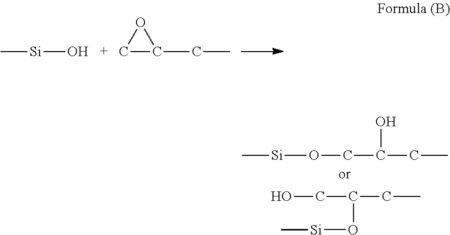

A blending mass ratio (primary particle:treating agent) of the primary particles to the treating agent is not particularly limited, and may be appropriately selected in accordance with the intended purpose. The blending mass ratio is preferably from 100:0.01 through 100:50. As the amount of the treating agent increases, the degree of cohesion tends to increase.

A method of blending the primary particles and the treating agent is not particularly limited, and may be appropriately selected in accordance with the intended purpose. Examples of the blending method include a method of mixing the primary particles and the treating agent by means of any of mixers known in the art (e.g., a spray dryer). When the mixing is performed, the treating agent may be mixed with the primary particles after the preparation of the primary particles. Alternatively, the primary particles may be prepared in the presence of the treating agent to prepare in a single step reaction.

A firing temperature of the primary particles and the treating agent is not particularly limited, and may be appropriately selected in accordance with the intended purpose. The firing temperature is preferably 450° C. or higher and 2,500° C. or lower. When the firing temperature is 450° C. or higher, the proportion of the primary particles per 1,000 particles of the external additive is 30% or less.

Duration of firing the primary particles and the treating agent is not particularly limited, and may be appropriately selected in accordance with the intended purpose. The firing duration is preferably from 0.5 hours through 30 hours, and more preferably 8 hours or longer and 16 hours or shorter.

### ——Parameters of Cohesive Particles——

The cohesive particles are not particularly limited, provided that a proportion of the primary particles per 1,000 particles of the external additives is 30% or less. The cohesive particles may be appropriately selected in accordance with the intended purpose. The proportion of the primary particles per 1,000 particles of the external additive is preferably 20% or less.

Since the cohesive particles maintains aggregation force (or cohesive force) between the primary particles under certain stirring conditions, durability of a resulting toner is assured.

The number of primary particles per 1,000 particles of the external additive is measured by stirring 0.5 g of the external additive and 49.5 g of a carrier placed in a 50 mL bottle by means of a mixing and stirring device for 10 minutes at 67 Hz, followed by observing the particles of the external additive under a scanning electron microscope.

When the aggregation force of the cohesive particles is strong, i.e., the proportion of the primary particles (e.g., the particles indicated with the numerical reference 4 in FIG. 3) per 1,000 particles of the external additive is less than 30% as depicted in FIG. 3, the number of the primary particles generated by cracking or breaking the cohesive particles of the external additive in the toner due to loads applied by a developing device etc. decreases. Consequently, a phenomenon that the external additive particles are embedded in each toner base particle or are rolled on a transfer member or image bearer is minimized, and a high transferring rate of a resulting toner may be maintained over a long period.

When the aggregation force of the cohesive particles is weak, i.e., the proportion of the primary particles (e.g., the particles indicated with the numerical reference 4 in FIG. 4) per 1,000 particles of the external additive is greater than 30% as depicted in FIG. 4, the number of the primary particles generated by cracking or breaking the cohesive particles of the external additive in the toner due to loads applied by a developing device etc. increases. Consequently, the proportion of spherical primary particles increases. The increased proportion of the spherical primary particles of the external additive may cause a phenomenon that the external additive particles are rolled on an image bearer etc. or embedded in each toner base particle, thus a high transferring rate of a resulting toner may not be maintained over a long period.

The primary particles include primary particles generated by cracking or breaking the cohesive particles after stirring by means of the mixing and stirring device under the above-described conditions, and particles present as the primary particles even before the stirring. For example, the primary particles include particles that are not cohered to one another, like the particles indicated with the numerical reference 4 in FIGS. 3 and 4.

Shapes of the primary particles are not particularly limited, provided that the primary particles are not cohered to one another. The shapes of the primary particles may be appropriately selected in accordance with the intended purpose. For example, the primary particles are often present as approximately spheres, like the particles 4 in FIGS. 3 and 4.

A method of confirming the presence of the primary particles is not particularly limited, and may be appropriately selected in accordance with the intended purpose. The method is preferably a method of confirming the presence of primary particles standing alone through observation under a scanning electron microscope (SEM).

A measuring method of the volume average particle diameter of the primary particles is not particularly limited, and may be appropriately selected in accordance with the intended purpose. The volume average particle diameter of the primary particles can be determined by measuring particle diameters of the primary particles in field of view of a scanning electron microscope (FE-SEM, acceleration voltage: from 5 kV through 8 kV, magnification: from 8,000× through 10,000×) and calculating an average value of the measured particle diameters (the number of particles to be measured: 100 particles or more).

The proportion of the primary particles each standing alone per 1,000 particles of the external additive is determined by, after the stirring, observing the particles of the external additive under a scanning electron microscope, and counting each particle standing alone, like the particle indicated with the numerical reference 4 in FIGS. 3 and 4, as one primary particle.

When the 1,000 particles are measured, if cohesive particles each formed of two or more particles cohered to one another are detected by the observation using the scanning electron microscope, each cohesive particle is counted as one particle.

As the mixing and stirring device, a rocking mill (available from Seiwa Giken Co., Ltd.) is used.

The carrier is not particularly limited, and may be appropriately selected in accordance with the intended purpose. A coated ferrite powder is preferably used as the carrier, where the coated ferrite powder is obtained by applying a coating liquid for forming an alumina particle-containing acryl/silicone resin coating layer onto surfaces of fired ferrite particles, and drying the coated ferrite particles.

The 50 mL bottle is not particularly limited, and may be appropriately selected in accordance with the intended purpose. Examples of the 50 mL bottle include a commercially available glass bottle (available from NICHIDEN-RIKA GLASS CO., LTD.).

### ——Properties of Cohesive Particles——

The degree of cohesion of the cohesive particles (i.e., the volume average particle diameter of the secondary particles/the volume average particle diameter of the primary particles) is not particularly limited, and may be appropriately selected in accordance with the intended purpose. The degree of cohesion is preferably from 1.5 through 4.0. When the degree of cohesion is less than 1.5, the particles of the external additive tend to roll into recesses formed at a surface of each toner base particle, leading to impaired transfer properties of a resultant toner. When the degree of cohesion is greater than 4.0, the external additive tends to detach from a toner. The detached external additive particles may cause carrier contamination, or may form scratches or damage on a photoconductor, thus image defects may appear as time passes.

A method of confirming whether the primary particles are cohered in the cohesive particle is not particularly limited, and may be appropriately selected in accordance with the intended purpose. The method is preferably a method where the particles of the external additive are observed under a scanning electron microscope (SEM) to confirm that the primary particles are cohered to one another.

Use of the cohesive particles realizes high flowability of a toner, and minimizes a phenomenon that the external additive particles are embedded in each toner base particle or rolled on an image bearer etc. when loads are applied to the toner by stirring or the like inside a developing device. Therefore, the toner can maintain a high transferring rate over a long period.

An amount of the external additive is not particularly limited, and may be appropriately selected in accordance with the intended purpose. The amount of the external additive is preferably from 0.1 parts by mass through 5.0 parts by mass relative to 100 parts by mass of the toner base particles.

### <Toner Base Particles>

Each of the toner base particles (may be also referred to as “toner bases,” or “base particles” hereinafter) includes a binder resin, a colorant, and a release agent, and may further include other components according to the necessity.

### <<Binder Resin>>

The binder resin is not particularly limited, and may be appropriately selected in accordance with the intended purpose. Examples of the binder resin include a polyester resin, a styrene-acrylic resin, a polyol resin, a vinyl-based resin, a polyurethane resin, an epoxy resin, a polyamide resin, a polyimide resin, a silicon-based resin, a phenol resin, a melamine resin, a urea resin, an aniline resin, an ionomer resin, and a polycarbonate resin. The above-listed examples may be used alone or in combination. Among the above-listed examples, a polyester resin is preferable because the polyester resin can impart flexibility to a resulting toner.

### <<<Polyester Resin>>>

The polyester resin is not particularly limited, and may be appropriately selected in accordance with the intended purpose. Examples of the polyester resin include a crystalline polyester resin, an amorphous polyester resin, and a modified polyester resin. The above-listed examples may be used alone or in combination.

### —Amorphous Polyester Resin—

The amorphous polyester resin (may be also referred to as “amorphous polyester,” “non-crystalline polyester,” “a non-crystalline polyester resin,” “an unmodified polyester resin,” or “a polyester resin component A” hereinafter) is not particularly limited, and may be appropriately selected in accordance with the intended purpose. Examples of the amorphous polyester resin include an amorphous polyester resin obtained through a reaction between a polyol and a polycarboxylic acid.

In the present disclosure, the amorphous polyester resin is a polyester resin obtained through a reaction between a polyol and a polycarboxylic acid as described above. A modified polyester resin, such as the below-described prepolymer, and a modified polyester resin obtained through a crosslinking reaction and/or an elongation reaction of the prepolymer are not classified as the amorphous polyester resin, but are classified as a modified polyester resin in the present disclosure.

The non-crystalline polyester is a polyester resin component soluble to tetrahydrofuran (THF).

The non-crystalline polyester (also referred to as the “polyester resin component A”) is preferably a linear polyester resin.

Examples of the polyol include a diol.

Examples of the diol include: a bisphenol A (C2-C3) alkylene oxide adduct (the number of moles added: from 1 through 10), such as polyoxypropylene(2.2)-2,2-bis(4-hydroxyphenyl)propane, and polyoxyethylene(2.2)-2,2-bis(4-hydroxyphenyl)propane; ethylene glycol; propylene glycol; hydrogenated bisphenol A; and a hydrogenated bisphenol A (C2-C3) alkylene oxide adduct (the number of moles added: from 1 through 10). The above-listed examples may be used alone or in combination. Among the above-listed examples, the polyol preferably includes 40 mol % or greater of an alkylene glycol.

Examples of the polycarboxylic acid include dicarboxylic acid.

Examples of the dicarboxylic acid include adipic acid, phthalic acid, isophthalic acid, terephthalic acid, fumaric acid, maleic acid, and a C1-C20 alkyl group or C2-C20 alkenyl group-substituted succinic acid (e.g., dodecenyl succinic acid, and octyl succinic acid). The above-listed examples may be used alone or in combination. Among the above-listed examples, the polycarboxylic acid is preferably polycarboxylic acid including 50 mol % or greater of terephthalic acid.

For adjusting an acid value and a hydroxyl value, the polyester resin component A may include a trivalent or higher carboxylic acid and/or trivalent or higher alcohol, or a trivalent or higher epoxy compound at terminals of the molecular chain of the polyester resin component A.

Among the above-listed examples, a trivalent or higher aliphatic alcohol is preferably included because adequate glossiness and image density can be imparted to a resulting image without unevenness.

Examples of the trivalent or higher carboxylic acid include trimellitic acid, pyromellitic acid, and acid anhydrides of the foregoing carboxylic acids.

Examples of the trivalent or higher alcohol include glycerin, pentaerythritol, and trimethylolpropane.

A molecular weight of the polyester resin component A is not particularly limited, and may be appropriately selected in accordance with the intended purpose. The molecular weight of the polyester resin component A is preferably within the following ranges.

A weight average molecular weight (Mw) of the polyester resin component A is preferably from 3,000 through 10,000, and more preferably from 4,000 through 7,000.

A number average molecular weight (Mn) of the polyester resin component A is preferably from 1,000 through 4,000, and more preferably from 1,500 through 3,000.

A molecular weight ratio (Mw/Mn) of the polyester resin component A is preferably from 1.0 through 4.0, and more preferably from 1.0 through 3.5.

For example, the weight average molecular weight and the number average molecular weight can be measured by gel permeation chromatography (GPC).

The reasons for the above-described ranges of the weight average molecular weight and the number average molecular weight are as follows. When the weight average molecular weight and the number average molecular weight are too small, heat-resistant storage stability of a resulting toner and durability of the toner against stress, such as stirring inside a developing device, may be impaired. When the weight average molecular weight and the number average molecular weight are too large, viscoelasticity of a resulting toner is high as the toner is melted, thus the toner may have inadequate low-temperature fixability. When the amount of the component having a molecular weight of 600 or less is too large, heat-resistant storage stability of a resulting toner and durability of the toner against stress, such as stirring inside a developing device, may be impaired. When the amount of the component having a molecular weight of 600 or less is too small, low-temperature fixability of a resulting toner may be impaired.

An amount of the THF-soluble component having a molecular weight of 600 or less is preferably from 2% by mass through 10% by mass.

Examples of a method of adjusting the amount of the THF-soluble component having a molecular weight of 600 or less include a method where the polyester resin component A is extracted with methanol, and the component having a molecular weight of 600 or less is removed from the extracted polyester resin component A to purify.

An acid value of the polyester resin component A is not particularly limited, and may be appropriately selected in accordance with the intended purpose. The acid value of the polyester resin component A is preferably from 1 mgKOH/g through 50 mgKOH/g, and more preferably from 5 mgKOH/g through 30 mgKOH/g. When the acid value of the amorphous polyester resin A is 1 mgKOH/g or greater, a toner tends to be negatively charged, and affinity between paper and the toner increases during fixing on the paper to thereby improve low-temperature fixability. When the acid value of the polyester resin component A is 50 mgKOH/g or less, a problem associated with charging stability, particularly reduction in charging stability due to fluctuations of environmental conditions, can be prevented.

A hydroxyl value of the polyester resin component A is not particularly limited, and may be appropriately selected in accordance with the intended purpose. The hydroxyl value of the polyester resin component A is preferably 5 mgKOH/g or greater.

A glass transition temperature (Tg) of the polyester resin component A is preferably from 40° C. through 65° C., more preferably from 45° C. through 65° C., and even more preferably from 50° C. through 60° C. When Tg is 40° C. or higher, heat-resistant storage stability of a resulting toner, and durability of the toner against stress, such as stirring inside a developing device, improve. In addition, filming resistance of the toner improves. When Tg is 65° C. or lower, a resulting toner deforms desirably upon application of heat and pressure during fixing, and low-temperature fixability of the toner improves.

An amount of the polyester resin component A is preferably from 80 parts by mass through 90 parts by mass relative to 100 parts by mass of the toner.

### —Modified Polyester Resin—

The modified polyester resin (may be also referred to as “modified polyester” or a “polyester resin component C” hereinafter) is not particularly limited, and may be appropriately selected in accordance with the intended purpose. Examples of the modified polyester resin include a reaction product of a reaction between an active hydrogen group-containing compound and the polyester resin having a site reactive with the active hydrogen group-containing compound (may be referred to as a “prepolymer” or a “polyester prepolymer” in the present specification).

The modified polyester is a polyester resin insoluble to tetrahydrofuran (THF). The tetrahydrofuran (THF)-insoluble polyester resin component reduces Tg or melt viscosity of a resulting toner. The tetrahydrofuran (THF)-insoluble polyester resin component has a branched structure in a molecular skeleton thereof, and molecular chains of the branches form a three-dimensional network structure. Therefore, the THF-insoluble polyester resin component imparts rubber-like characteristics to a resulting toner, while maintaining low-temperature fixability. The rubber-like characteristics are characteristics whereby a toner deforms at a low temperature but does not flow.

Since the polyester resin component C includes the active hydrogen group-containing compound and the sites reactive with the active hydrogen group-containing compound, the sites acct as pseudo-crosslink points to enhance rubber-like characteristics of the non-crystalline polyester resin A. As a result, a toner having excellent heat-resistant storage stability and hot offset resistance can be produced.

### ——Active Hydrogen Group-Containing Compound——

The active hydrogen group-containing compound is a compound that can react with the polyester resin having a site reactive with the active hydrogen group-containing compound.

The active hydrogen group is not particularly limited, and may be appropriately selected in accordance with the intended purpose. Examples of the active hydrogen group include a hydroxyl group (e.g., an alcoholic hydroxyl group and a phenolic hydroxyl group), an amino group, a carboxyl group, and a mercapto group. The above-listed examples may be used alone or in combination.

The active hydrogen group-containing compound is not particularly limited, and may be appropriately selected in accordance with the intended purpose. When the polyester resin having a site reactive with the active hydrogen group-containing compound is a polyester resin including an isocyanate group, the active hydrogen group-containing compound is preferably an amine because a high molecular weight of the polyester resin can be formed through an elongation reaction or cross-linking reaction with the polyester resin.

The amines are not particularly limited, and may be appropriately selected in accordance with the intended purpose. Examples of the amines include a diamine, a trivalent or higher amine, an amino alcohol, an amino mercaptan, an amino acid, and any of the above-listed amines in which an amino group is blocked. The above-listed examples may be used alone or in combination.

Among the above-listed examples, a diamine, and a mixture including a diamine and a small amount of a trivalent or higher amine are preferable.

The diamine is not particularly limited, and may be appropriately selected in accordance with the intended purpose. Examples of the diamine include an aromatic diamine, an alicyclic diamine, and an aliphatic diamine. The aromatic diamine is not particularly limited, and may be appropriately selected in accordance with the intended purpose. Examples of the aromatic diamine include phenylene diamine, diethyltoluene diamine, and 4,4′-diaminodiphenylmethan. The alicyclic diamine is not particularly limited, and may be appropriately selected in accordance with the intended purpose. Examples of the alicyclic diamine include 4,4′-diamino-3,3′-dimethyldicyclohexylmethane, diaminocyclohexane, and isophorone diamine. The aliphatic diamine is not particularly limited, and may be appropriately selected in accordance with the intended purpose. Examples of the aliphatic diamine include ethylene diamine, tetramethylene diamine, and hexamethylene diamine.

The trivalent or higher amine is not particularly limited, and may be appropriately selected in accordance with the intended purpose. Examples of the trivalent or higher amine include diethylene triamine, and triethylene tetramine.

The amino alcohol is not particularly limited, and may be appropriately selected in accordance with the intended purpose. Examples of the amino alcohol include ethanol amine, and hydroxyethylaniline.

The amino mercaptan is not particularly limited, and may be appropriately selected in accordance with the intended purpose. Examples of the amino mercaptan include aminoethyl mercaptan, and aminopropyl mercaptan.

The amino acid is not particularly limited, and may be appropriately selected in accordance with the intended purpose. Examples of the amino acid include amino propionic acid, and amino caproic acid.

The amine in which an amino group is blocked is not particularly limited, and may be appropriately selected in accordance with the intended purpose. Examples thereof include ketimine compounds and oxazoline compounds obtained by blocking an amino group with any of ketones, such as acetone, methyl ethyl ketone, and methyl isobutyl ketone.

——Polyester Resin Having Site Reactive with Active Hydrogen Group-Containing Compound——
The polyester resin having a site reactive with the active hydrogen group-containing compound is not particularly limited, and may be appropriately selected in accordance with the intended purpose. Examples thereof include a polyester resin including an isocyanate group (may be referred to as an “isocyanate group-containing polyester resin” or an “isocyanate group-containing polyester prepolymer”). The polyester resin including an isocyanate group is not particularly limited, and may be appropriately selected in accordance with the intended purpose. Examples of the isocyanate group-containing polyester resin include a reaction product between an active hydrogen group-containing polyester resin and polyisocyanate, where the active hydrogen group-containing polyester is obtained through polycondensation between a polyol and a polycarboxylic acid.

Th polyol is not particularly limited, and may be appropriately selected in accordance with the intended purpose. Examples of the polyol include a diol, a trivalent or higher alcohol, and a mixture of a diol and a trivalent or higher alcohol. The above-listed examples may be used alone or in combination. Among the above-listed examples, a polyol is preferably a diol, or a mixture including a diol and a small amount of a trivalent or higher alcohol.

The diol is not particularly limited, and may be appropriately selected in accordance with the intended purpose. Examples of the diol include a chain alkylene glycol, an oxyalkylene group-containing diol, an alicyclic diol, bisphenols, alicyclic diol alkylene oxide adducts, and bisphenol alkylene oxide adducts.

Examples of the chain alkylene glycol include ethylene glycol, 1,2-propyleneglycol, 1,3-propyleneglycol, 1,4-butanediol, and 1,6-hexanediol.

Examples of the oxyalkylene group-containing diol include diethylene glycol, triethylene glycol, dipropylene glycol, triethylene glycol, polypropylene glycol, and polytetramethylene glycol.

Examples of the alicyclic diol include 1,4-cyclohexanedimethanol, and hydrogenated bisphenol A.

Examples of the bisphenols include bisphenol A, bisphenol F, and bisphenol S.

Examples of the alkylene oxide include ethylene oxide, propylene oxide, and butylene oxide.

The number of carbon atoms of the chain alkylene glycol is not particularly limited, and may be appropriately selected in accordance with the intended purpose. The number of carbon atoms thereof is preferably from 2 through 12.

Among the above-listed examples, at least one of a C2-C12 chain alkylene glycol, and an alkylene oxide adduct of bisphenol is preferable, and an alkylene oxide adduct of bisphenol, or a mixture including an alkylene oxide adduct of bisphenol and a C2-C12 chain alkylene glycol is more preferable.

The trivalent or higher alcohol is not particularly limited, and may be appropriately selected in accordance with the intended purpose. Examples of the trivalent or higher alcohol include a trivalent or higher aliphatic alcohol, trivalent or higher polyphenols, and an alkylene oxide adduct of trivalent or higher polyphenols.

The trivalent or higher aliphatic alcohol is not particularly limited, and may be appropriately selected in accordance with the intended purpose. Examples of the trivalent or higher aliphatic alcohol include glycerin, trimethylol ethane, trimethylol propane, pentaerythritol, and sorbitol.

The trivalent or higher polyphenols are not particularly limited and may be appropriately selected in accordance with the intended purpose. Examples of the trivalent or higher polyphenols include trisphenol PA, phenol novolac, and cresol novolac.

Examples of the alkylene oxide adduct of trivalent or higher polyphenols include alkylene oxide (e.g., ethylene oxide, propylene oxide, and butylene oxide) adducts of trivalent or higher polyols.

When the diol and the trivalent or higher alcohol are used as a mixture, a mass ratio (trivalent or higher alcohol/diol) of the trivalent or higher alcohol to the diol is not particularly limited, and may be appropriately selected in accordance with the intended purpose. The mass ratio (trivalent or higher alcohol/diol) is preferably from 0.01% by mass through 10% by mass, and more preferably from 0.01% by mass through 1% by mass.

The polycarboxylic acid is not particularly limited, and may be appropriately selected in accordance with the intended purpose. Examples of the polycarboxylic acid include a dicarboxylic acid, a trivalent or higher carboxylic acid, and a mixture of a dicarboxylic acid and a trivalent or higher carboxylic acid. The above-listed examples may be used alone or in combination. Among the above-listed examples, a dicarboxylic acid, and a mixture including a dicarboxylic acid and a small amount of a trivalent or higher polycarboxylic acid are preferable.

The dicarboxylic acid is not particularly limited, and may be appropriately selected in accordance with the intended purpose. Examples of the dicarboxylic acid include a divalent alkanoic acid, a divalent alkenoic acid, and an aromatic dicarboxylic acid.

The divalent alkanoic acid is not particularly limited, and may be appropriately selected in accordance with the intended purpose. Examples of the divalent alkanoic acid include succinic acid, adipic acid, and sebacic acid.

The divalent alkenoic acid is not particularly limited, and may be appropriately selected in accordance with the intended purpose. The divalent alkenoic acid is preferably a C4-C20 divalent alkenoic acid. The C4-C20 divalent alkenoic acid is not particularly limited, and may be appropriately selected in accordance with the intended purpose. Examples of the C4-C20 divalent alkenoic acid include maleic acid, and fumaric acid.

The aromatic dicarboxylic acid is not particularly limited, and may be appropriately selected in accordance with the intended purpose. The aromatic dicarboxylic acid is preferably a C8-C20 aromatic dicarboxylic acid. The C8-C20 aromatic dicarboxylic acid is not particularly limited, and may be appropriately selected in accordance with the intended purpose. Examples of the C8-C20 aromatic dicarboxylic acid include phthalic acid, isophthalic acid, terephthalic acid, and naphthalene dicarboxylic acid.

The trivalent or higher carboxylic acid is not particularly limited, and may be appropriately selected in accordance with the intended purpose. Examples of the trivalent or higher carboxylic acid include a trivalent or higher aromatic carboxylic acid.

The trivalent or higher aromatic carboxylic acid is not particularly limited, and may be appropriately selected in accordance with the intended purpose. The trivalent or higher aromatic carboxylic acid is preferably a C9-C20 trivalent or higher aromatic carboxylic acid. The C9-C20 trivalent or higher aromatic carboxylic acid is not particularly limited, and may be appropriately selected in accordance with the intended purpose. Examples of the C9-C20 trivalent or higher aromatic carboxylic acid include trimellitic acid, and pyromellitic acid.

As the polycarboxylic acid, an acid anhydride or lower alkyl ester of any of a dicarboxylic acid, trivalent or higher carboxylic acid, or a mixture including a dicarboxylic acid and a trivalent or higher carboxylic acid may be used.

The lower alkyl ester is not particularly limited, and may be appropriately selected in accordance with the intended purpose. Examples of the lower alkyl ester include a methyl ester, an ethyl ester, and an isopropyl ester.

When the dicarboxylic acid and the trivalent or higher carboxylic acid are used as a mixture, a mass ratio (trivalent or higher carboxylic acid/dicarboxylic acid) of the trivalent or higher carboxylic acid to the dicarboxylic acid is not particularly limited, and may be appropriately selected in accordance with the intended purpose. The mass ratio (trivalent or higher carboxylic acid/dicarboxylic acid) is preferably from 0.01% by mass through 10% by mass, and more preferably from 0.01% by mass through 1% by mass.

When the polyol and the polycarboxylic acid are reacted through polycondensation, an equivalent ratio (hydroxyl group of polyol/carboxyl group of polycarboxylic acid) of a hydroxyl group of the polyol to a carboxyl group of the polycarboxylic acid is not particularly limited, and may be appropriately selected in accordance with the intended purpose. The equivalent ratio (hydroxyl group of polyol/carboxyl group of polycarboxylic acid) is preferably from 1 through 2, more preferably from 1 through 1.5, and particularly preferably from 1.02 through 1.3.

An amount of the constituent unit derived from the polyol in the isocyanate group-containing polyester prepolymer is not particularly limited, and may be appropriately selected in accordance with the intended purpose. The amount of the constituent unit is preferably from 0.5% by mass through 40% by mass, more preferably from 1% by mass through 30% by mass, and particularly preferably from 2% by mass through 20% by mass.

When the amount of the constituent unit is less than 0.5% by mass, hot offset resistance of a resulting toner may be impaired, and it may be difficult to achieve both heat-resistant storage stability and low-temperature fixability of the toner. When the amount of the constituent unit is greater than 40% by mass, low-temperature fixability of a resulting toner may be impaired.

The polyisocyanate is not particularly limited, and may be appropriately selected in accordance with the intended purpose. Examples of the polyisocyanate include an aliphatic diisocyanate, alicyclic diisocyanate, aromatic diisocyanate, aromatic aliphatic diisocyanate, isocyanurate, and products obtained by blocking the above-listed polyisocyanates with a phenol derivative, oxime, or caprolactam.

The aliphatic diisocyanate is not particularly limited, and may be appropriately selected in accordance with the intended purpose. Examples of the aliphatic diisocyanate include tetramethylene diisocyanate, hexamethylene diisocyanate, 2,6-diisocyanatocaproic acid methyl ester, octamethylene diisocyanate, decamethylene diisocyanate, dodecamethylene diisocyanate, tetradecamethylene diisocyanate, trimethylhexane diisocyanate, and tetramethylhexane diisocyanate.

The alicyclic diisocyanate is not particularly limited, and may be appropriately selected in accordance with the intended purpose. Examples of the alicyclic diisocyanate include isophorone diisocyanate, and cyclohexylmethane diisocyanate.

The aromatic diisocyanate is not particularly limited, and may be appropriately selected in accordance with the intended purpose. Examples of the aromatic diisocyanate include tolylene diisocyanate, diisocyanatodiphenyl methane, 1,5-naphthylenediisocyanate, 4,4′-diisocyanatodiphenyl, 4,4′-diisocyanato-3,3′-dimethyldiphenyl, 4,4′-diisocyanato-3-methyldiphenylmethane, and 4,4′-diisocyanato-diphenyl ether.

The aromatic aliphatic diisocyanate is not particularly limited, and may be appropriately selected in accordance with the intended purpose. Examples of the aromatic aliphatic diisoyanate include α,α,α′,α′-tetramethylxylenediisocyanate.

The isocyanurate is not particularly limited, and may be appropriately selected in accordance with the intended purpose. Examples of the isocyanurate include tris(isocyanatalkyl)isocyanurate, and tris(isocyanatocycloalkyl)isocyanurate. The above-listed examples may be used alone or in combination.

When the polyisocyanate is reacted with the polyester resin including a hydroxyl group, an equivalent ratio (NCO/OH) of an isocyanate group of the polyisocyanate to a hydroxyl group of the polyester resin is not particularly limited, and may be appropriately selected in accordance with the intended purpose. The equivalent ratio (NCO/OH) is preferably from 1 through 5, more preferably from 1.2 through 4, and particularly preferably from 1.5 through 2.5. When the equivalent ratio (NCO/OH) is less than 1, hot offset resistance of a resulting toner may be impaired. When the equivalent ratio (NCO/OH) is greater than 5, low-temperature fixability of a resulting toner may be impaired.

An amount of the constituent unit derived from polyisocyanate in the isocyanate group-containing polyester prepolymer is not particularly limited, and may be appropriately selected in accordance with the intended purpose. The amount of the constituent unit is preferably from 0.5% by mass through 40% by mass, more preferably from 1% by mass through 30% by mass, and particularly preferably from 2% by mass through 20% by mass. When the amount of the constituent unit is less than 0.5% by mass, hot offset resistance of a resulting toner may be impaired. When the amount of the constituent unit is greater than 40% by mass, low-temperature fixability of a resulting toner may be impaired.

The average number of isocyanate groups per molecule of the isocyanate group-containing polyester prepolymer is not particularly limited, and may be appropriately selected in accordance with the intended purpose. The average number of isocyanate groups is preferably 1 or greater, more preferably from 1.5 through 3, and particularly preferably from 1.8 through 2.5. When the average number of isocyanate groups is less than 1, a molecular weight of a resulting modified polyester resin is small, and the small molecular weight of the modified polyester resin may lead to inadequate hot offset resistance of a resulting toner.

The modified polyester resin can be produced by a one-shot method etc. As one example, a production method of a urea-modified polyester resin will be described hereinafter.

First, a polyol and a polycarboxylic acid are heated to a temperature ranging from 150° C. through 280° C. in the presence of a catalyst (e.g., tetrabutoxy titanate, and dibutyl tin oxide) optionally under reduced pressure to remove generated water, to thereby obtain a hydroxyl group-containing polyester resin. Next, the hydroxyl group-containing polyester resin and polyisocyanate are allowed to react at a temperature ranging from 40° C. through 140° C., to thereby obtain an isocyanate group-containing polyester prepolymer. Moreover, the isocyanate group-containing polyester prepolymer and amines are allowed to react at a temperature ranging from 0° C. through 140° C., to thereby obtain a urea-modified polyester resin.

The number average molecular weight (Mn) of the modified polyester resin is not particularly limited, and may be appropriately selected in accordance with the intended purpose. The number average molecular weight (Mn) of the modified polyester resin as measured by gel permeation chromatography (GPC) is preferably from 1,000 through 10,000, and more preferably from 1,500 through 6,000.

The weight average molecular weight of the modified polyester resin is not particularly limited, and may be appropriately selected in accordance with the intended purpose. The weight average molecular weight of the modified polyester resin as measured by gel permeation chromatography (GPC) is preferably 20,000 or greater and 1,000,000 or less.

When the weight average molecular weight is 20,000 or greater, problems, such as toner flow at a low temperature, and poor heat-resistant storage stability, or a problem of poor hot offset resistance due to low viscosity at the time of melting can be prevented.

When the hydroxyl group-containing polyester resin and polyisocyanate are allowed to react, or when the isocyanate group-containing polyester prepolymer and amines are allowed to react, a solvent may be optionally used.

The solvent is not particularly limited, and may be appropriately selected in accordance with the intended purpose. Examples of the solvent include solvents inert to isocyanate groups, such as aromatic solvents, ketones, esters, amides, and ethers. Examples of the aromatic solvents include toluene, and xylene. Examples of the ketones include acetone, methyl ethyl ketone, and methyl isobutyl ketone. Examples of the esters include ethyl acetate. Examples of the amides include dimethylformamide, and dimethylacetamide. Examples of the ethers include tetrahydrofuran.

A glass transition temperature of the modified polyester resin is preferably −60° C. or higher and 0° C. or lower, and more preferably −40° C. or higher and −20° C. or lower.

When the glass transition temperature of the modified polyester resin is −60° C. or higher, the toner is prevented from flowing at a low temperature, thus heat-resistant storage stability and anti-filming properties can be assured.

When the glass transition temperature of the modified polyester resin is 0° C. or lower, the toner can be adequately deformed by heat and pressure applied during fixing, thus low-temperature fixability can be exhibited adequately.

An amount of the modified polyester is not particularly limited, and may be appropriately selected in accordance with the intended purpose. The amount of the modified polyester relative to 100 parts by mass of the toner is preferably from 1 part by mass through 15 parts by mass, and more preferably from 5 parts by mass through 10 parts by mass.

A molecular structure of the polyester resin component A or C can be confirmed by solution or solid NMR spectroscopy, X-ray diffraction spectroscopy, GC/MS, LC/MS, or IR spectroscopy.

As a simple method of confirming the molecular structure of the polyester resin component A or C, there is a method where a compound having no absorption, which is based on 5CH (out plane bending) of olefin, at 965±10 cm⁻¹ or 990±10 cm⁻¹ in an infrared absorption spectrum is detected as a non-crystalline polyester resin.

### —Crystalline Polyester—

The crystalline polyester resin (may be also referred to as “crystalline polyester,” or a “polyester resin component D” hereinafter) is not particularly limited, and may be appropriately selected in accordance with the intended purpose. Examples of the crystalline polyester resin include a crystalline polyester resin obtained through a reaction between a polyol and a polycarboxylic acid.

The crystalline polyester resin has high crystallinity, thus the crystalline polyester resin has heat fusion characteristics such that viscosity of the crystalline polyester drastically changes at a temperature around a fixing onset temperature (e.g., a melt onset temperature).

Since the crystalline polyester resin having such properties is used in combination with the amorphous polyester resin, excellent heat-resistant storage stability is obtained at temperatures up to the melt onset temperature owing to the crystallinity of the crystalline polyester resin. At the melt onset temperature, drastic reduction in viscosity (sharp melt) is caused due to melting of the crystalline polyester resin, making the crystalline polyester resin compatible to the amorphous polyester resin. The above-described rapid reduction in the viscosity allows a resulting toner to be fixed. Therefore, the toner having both excellent heat-resistant storage stability and low temperature fixing ability can be provided. Moreover, a desired release range (a difference between the minimum fixing temperature and a hot-offset onset temperature) is also achieved.

In the present disclosure, as described above, the crystalline polyester resin means a resin obtained using a polyvalent alcohol, and a polyvalent carboxylic acid. A modified polyester resin, such as the prepolymer and a resin obtained through a cross-linking and/or elongation reaction of the prepolymer, is not classified as the crystalline polyester resin.

### ——Polyol——

The polyol is not particularly limited, and may be appropriately selected in accordance with the intended purpose. Examples of the polyol include a diol, and a trivalent or higher polyol.

Examples of the diol include a saturated aliphatic diol.

Examples of the saturated aliphatic diol include a straight-chain saturated aliphatic diol and a branched-chain saturated aliphatic diol. The above-listed examples may be used alone or in combination. Among the above-listed examples, a straight-chain saturated aliphatic diol is preferable, and a C2-C12 straight-chain saturated aliphatic diol is more preferable, because use of the straight-chain saturated aliphatic diol can improve crystallinity and lower a melting point.

Examples of the saturated aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanediol.

Among the above-listed examples, ethylene glycol, 1,4-butanediol, 1,6-hexanediol, 1,8-octanediol, 1,10-decanediol, and 1,12-dodecanediol are preferable because a resulting crystalline polyester resin has high crystallinity and excellent sharp melting properties.

Examples of the trivalent or higher alcohol include glycerin, trimethylolethane, trimethylolpropane, and pentaerythritol.

### ——Polycarboxylic Acid——

The polycarboxylic acid is not particularly limited, and may be appropriately selected in accordance with the intended purpose. Examples of the polycarboxylic acid include a divalent carboxylic acid, and a trivalent or higher carboxylic acid.

Examples of the divalent carboxylic acid include: a saturated aliphatic dicarboxylic acid, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; aromatic dicarboxylic acid, such as dibasic acid (e.g., phthalic acid, isophthalic acid, terephthalic acid, and naphthalene-2,6-dicarboxylic acid); malonic acid, and mesaconic acid; anhydrides of the foregoing carboxylic acids; and lower (C1-C3) alkyl esters of the foregoing carboxylic acids.

Examples of the trivalent or higher carboxylic acid include 1,2,4-benzenetricarboxylic acid, 1,2,5-benzenetricarboxylic acid, 1,2,4-naphthalenetricarboxylic acid, anhydrides of the foregoing carboxylic acids, and lower (C1-C3) alkyl esters of the foregoing carboxylic acids.

In addition to the saturated aliphatic dicarboxylic acid or aromatic dicarboxylic acid, moreover, a dicarboxylic acid having a sulfonic acid group may be included as the polycarboxylic acid. In addition to the saturated aliphatic dicarboxylic acid or aromatic dicarboxylic acid, furthermore, a dicarboxylic acid having a double bond may be included. The above-listed examples may be used alone or in combination.

The crystalline polyester resin is preferably formed from a C4-C12 straight-chain saturated aliphatic dicarboxylic acid and a C2-C12 straight-chain saturated aliphatic diol. Specifically, the crystalline polyester resin preferably includes a constituent unit derived from a C4-C12 saturated aliphatic dicarboxylic acid and a constituent unit derived from a C2-C12 saturated aliphatic diol. Such a crystalline polyester resin is preferable because excellent sharp melting properties can be imparted to a resulting toner to exhibit excellent low-temperature fixability.

In the present disclosure, the presence of crystallinity of the crystalline polyester resin can be confirmed by means of a crystallography X-ray diffractometer (e.g., X'Pert Pro MRD, available from Philips). A method of determining the crystallinity will be described hereinafter.

First, a sample is ground by a mortar and pestle to prepare sample powder. The obtained sample powder is uniformly deposited in a sample holder. Thereafter, the sample holder is set in the diffractometer, and the sample is measured to obtain a diffraction spectrum.

When a peak half value width of a peak having the maximum peak intensity among peaks in the range of 20°<2θ<25° is 2.0 or less, the sample is determined as having crystallinity.

In contrast to the crystalline polyester resin, the polyester resin that does not exhibit the above-described state is referred to as an amorphous polyester resin in the present specification.

The measuring conditions of the X-ray diffraction spectroscopy are as follows.

### [Measuring Conditions]

### Tension kV: 45 kV

### Current: 40 mA

### MPSS

### Upper

### Gonio

Scan mode: continuous
Start angle: 3°
End angle: 35°

### Angle Step: 0.02°

Incident beam optics
Divergence slit: Div slit ½
Deflection beam optics
Anti-scatter slit: As Fixed ½
Receiving slit: Prog rec slit

A melting point of the crystalline polyester resin is not particularly limited, and may be appropriately selected in accordance with the intended purpose. The melting point of the crystalline polyester resin is preferably 60° C. or higher and 80° C. or lower.

When the melting point is 60° C. or higher, the crystalline polyester resin does not melt at a low temperature, thus adequate heat-resistant storage stability of a resulting toner can be assured. When the melting point of the crystalline polyester resin is 80° C. or lower, the crystalline polyester resin adequately melts with heat applied during fixing, thus adequate low-temperature fixability of a resulting toner can be assured.

A molecular weight of the crystalline polyester resin is not particularly limited, and may be appropriately selected in accordance with the intended purpose.

The weight average molecular weight (Mw) of the ortho-chlorobenzene-soluble component of the crystalline polyester resin as measured by GPC is preferably from 3,000 through 30,000, and more preferably from 5,000 through 15,000.

The number average molecular weight (Mn) of the ortho-chlorobenzene-soluble component of the crystalline polyester resin as measured by GPC is preferably from 1,000 through 10,000, and more preferably from 2,000 through 10,000.

A ratio Mw/Mn of the molecular weights of the crystalline polyester resin is preferably from 1.0 through 10, and more preferably from 1.0 through 5.0.

The above-described ranges of the molecular weights of the crystalline polyester resin are preferable because a sharp molecular-weight distribution of the crystalline polyester resin imparts excellent low-temperature fixability to a resulting toner, whereas a large amount of a low molecular-weight component may impair heat-resistant storage stability of the toner.

An acid value of the crystalline polyester resin is not particularly limited, and may be appropriately selected in accordance with the intended purpose. For achieving desired low-temperature fixability in view of affinity between paper and the resin, the acid value of the crystalline polyester resin is preferably 5 mgKOH/g or greater, and more preferably 10 mgKOH/g or greater. For improving hot offset resistance, the acid value of the crystalline polyester resin is preferably 45 mgKOH/g or less.

A hydroxyl value of the crystalline polyester resin is not particularly limited, and may be appropriately selected in accordance with the intended purpose. For achieving desired low-temperature fixability and excellent chargeability, the hydroxyl value of the crystalline polyester resin is preferably from 0 mgKOH/g through 50 mgKOH/g, and more preferably from 5 mgKOH/g through 50 mgKOH/g.

A molecular structure of the crystalline polyester resin can be confirmed by solution or solid NMR spectroscopy, X-ray diffraction spectroscopy, GC/MS, LC/MS, or IR spectroscopy. As a simple method of confirming the molecule structure of the crystalline polyester resin, there is a method where a compound having absorption, which is based on 5CH (out plane bending) of an olefin, at 965±10 cm⁻¹ or 990±10 cm⁻¹ in an infrared absorption spectrum of the component is detected as a crystalline polyester resin.

An amount of the crystalline polyester resin is not particularly limited, and may be appropriately selected in accordance with the intended purpose. The amount of the crystalline polyester resin relative to 100 parts by mass of the toner is preferably from 3 parts by mass through 20 parts by mass, and more preferably from 5 parts by mass through 15 parts by mass. When the amount of the crystalline polyester resin is 3 parts by mass or greater, adequate sharp melting properties are assured owing to the crystalline polyester resin, and desired low-temperature fixability can be achieved. When the amount of the crystalline polyester resin is 20 parts by mass or less, adequate heat-resistant storage stability can be assured, thus image fogging can be prevented.

### <<Colorant>>

The colorant is not particularly limited, and may be appropriately selected in accordance with the intended purpose. Examples of the colorant include carbon black, a nigrosine dye, iron black, naphthol yellow S, Hansa yellow (10G, 5G, G), cadmium yellow, yellow iron oxide, yellow ocher, yellow lead, titanium yellow, polyazo yellow, oil yellow, Hansa yellow (GR, A, RN, R), pigment yellow L, benzidine yellow (G, GR), permanent yellow (NCG), Vulcan fast yellow (5G, R), tartrazine lake, quinoline yellow lake, anthrasan yellow BGL, isoindolinon yellow, red iron oxide, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone.

An amount of the colorant is not particularly limited, and may be appropriately selected in accordance with the intended purpose. The amount of the colorant is preferably from 1 part by mass through 15 parts by mass, and more preferably from 3 parts by mass through 10 parts by mass, relative to 100 parts by mass of the toner.

The colorant may be also used as a master batch in which the colorant forms a composite with a resin. Examples of the resin used for production of the master batch or kneaded together with the master batch include, in addition to the above-mentioned other polyester resins, polymers of styrene or substituted styrene [e.g., polystyrene, poly(p-chlorostyrene), and polyvinyl toluene], styrene-based copolymers (e.g., a styrene-p-chlorostyrene copolymer, a styrene-propylene copolymer, a styrene-vinyl toluene copolymer, a styrene-vinyl naphthalene copolymer, a styrene-methyl acrylate copolymer, a styrene-ethyl acrylate copolymer, a styrene-butyl acrylate copolymer, a styrene-octyl acrylate copolymer, a styrene-methyl methacrylate copolymer, a styrene-ethyl methacrylate copolymer, a styrene-butyl methacrylate copolymer, a styrene-methyl α-chloromethacrylate copolymer, a styrene-acrylonitrile copolymer, a styrene-methyl vinyl ketone copolymer, a styrene-butadiene copolymer, a styrene-isoprene copolymer, a styrene-acrylonitrile-indene copolymer, a styrene-maleic acid copolymer, and a styrene-maleic acid ester copolymer), polymethyl methacrylate, polybutyl methacrylate, polyvinyl chloride, polyvinyl acetate, polyethylene, polypropylene, polyester, an epoxy resin, an epoxypolyol resin, polyurethane, polyamide, polyvinyl butyral, a polyacrylic resin, rosin, modified rosin, a terpene resin, an aliphatic or alicyclic hydrocarbon resin, an aromatic petroleum resin, chlorinated paraffin, and paraffin wax. The above-listed examples may be used alone or in combination.

The master batch can be prepared by applying high shear force to a resin and colorant used for a master batch to mix and knead the mixture. In order to enhance the interaction between the colorant and the resin, an organic solvent may be used. Moreover, a flashing method is preferably used, since a wet cake of the colorant can be directly used without being dried. The flashing method is a method where an aqueous paste containing a colorant is mixed or kneaded with a resin and an organic solvent, and then the colorant is transferred into the resin, followed by removing the moisture and the organic solvent. A high-shearing disperser (e.g., a three-roll mill) is preferably used for the mixing and kneading.

### <<Release Agent>>

The release agent (e.g., wax) is not particularly limited, and may be appropriately selected from release agents known in the art. Examples of the release agent include natural wax, and synthetic wax. The above-listed examples may be used alone or in combination.

Examples of the natural wax include vegetable wax (e.g., carnauba wax, cotton wax, and Japanese wax), animal wax (e.g., bees wax and lanolin wax), mineral wax (e.g., ozocerite and ceresin), and petroleum wax (e.g., paraffin wax, microcrystalline wax, and petrolatum wax).

Examples of the synthetic wax include synthetic hydrocarbon wax (e.g., Fischer-Tropsch wax, polyethylene wax, and polypropylene wax), fatty acid amide-based compounds (e.g., an ester, ketone, an ether, 12-hydroxystearic acid amide, stearic acid amide, a phthalimide anhydride, and a chlorinated hydrocarbon), homopolymers or copolymers of polyacrylate (e.g., poly-n-stearylmethacrylate, and poly-n-laurylmethacrylate) that is a low molecular weight crystalline polymeric resin (e.g., a n-stearyl acrylate-ethyl methacrylate copolymer), and a crystalline polymer having a long alkyl chain at a side chain thereof.

Among the above-listed examples, hydrocarbon wax, such as paraffin wax, microcrystalline wax, Fischer-Tropsch wax, polyethylene wax, and polypropylene wax, is preferable.

A melting point of the release agent is not particularly limited, and may be appropriately selected in accordance with the intended purpose. The melting point of the release agent is preferably 60° C. or higher and 80° C. or lower. When the melting point of the release agent is 60° C. or higher, the release agent does not melt at a low temperature, thus adequate heat-resistant storage stability of a resulting toner can be assured. When the melting point of the release agent is 80° C. or lower, the release agent melts adequately when the temperature is in the fixing temperature range and the resin is melted, thus fixing offset can be prevented to prevent image defects.

An amount of the release agent is not particularly limited, and may be appropriately selected in accordance with the intended purpose. The amount of the release agent relative to 100 parts by mass of the toner is preferably from 2 parts by mass through 10 parts by mass, and more preferably from 3 parts by mass through 8 parts by mass. When the amount of the release agent is 2 parts by mass or greater, problems, such as poor high-temperature offset resistance of a resulting toner and poor low-temperature fixability of the toner during fixing, can be prevented. When the amount of the release agent is 10 parts by mass or less, problems, such as poor heat-resistant storage stability of a resulting toner and image fogging, may be prevented.

The toner base particles may each include other components. The above-mentioned other components are not particularly limited, provided that the components are constituent materials typically used for toner base particles. The components may be appropriately selected in accordance with the intended purpose.

An amount of the above-mentioned other compounds is not particularly limited, provided that properties or characteristics of the toner are not adversely affected. The amount of the above-mentioned other components may be appropriately selected in accordance with the intended purpose.

### <Other Components>

The above-mentioned other components are not particularly limited, provided that the components are constituent materials used for a general toner. The above-mentioned other components may be appropriately selected in accordance with the intended purpose. Examples of the above-mentioned other components include a charge-controlling agent, a flowability improving agent, a cleaning improving agent, and a magnetic material.

### —Charge-Controlling Agent—

The charge-controlling agent is not particularly limited, and may be appropriately selected in accordance with the intended purpose. Examples of the charge-controlling agent include a nigrosine-based dye, a triphenylmethane-based dye, a chrome-containing metal complex dye, a molybdic acid chelate pigment, a rhodamine-based dye, an alkoxy-based amine, a quaternary ammonium salt (including fluorine-modified quaternary ammonium), an alkylamide, phosphorus or a phosphorus compound, tungsten or a tungsten compound, a fluorosurfactant, a metal salt of salicylic acid, and a metal salt of a salicylic acid derivative.

Examples of commercial products of the charge-controlling agent include: nigrosine dye BONTRON 03, quaternary ammonium salt BONTRON P-51, metal-containing azo dye BONTRON S-34, oxynaphthoic acid-based metal complex E-82, salicylic acid-based metal complex E-84, and phenol condensate E-89 (all manufactured by ORIENT CHEMICAL INDUSTRIES CO., LTD); quaternary ammonium salt molybdenum complex TP-302 and TP-415 (all manufactured by Hodogaya Chemical Co., Ltd.); and LRA-901, and boron complex LR-147 (manufactured by Japan Carlit Co., Ltd.).

An amount of the charge-controlling agent cannot be set definitively, as the amount of the charge-controlling agent varies in accordance with the binder resin for use, the presence of additives optionally used, and a toner production method, such as a dispersion method. The amount of the charge-controlling agent is preferably from 0.1 parts by mass through 10 parts by mass, and more preferably from 0.2 parts by mass through 5 parts by mass, relative to 100 parts by mass of the binder resin. When the amount of the charge-controlling agent is greater than 10 parts by mass, excessive chargeability may be imparted to a resulting toner, which impairs a main effect as the charge-controlling agent. As a result, the electrostatic attraction force between the toner and the developing roller increases to lower flowability of a developer or image density of an image formed with the toner. The charge-controlling agent may be melt-kneaded with a master batch or resin, followed by dissolving or dispersing the charge-controlling agent in the master batch or the resin, or may be directly added to an organic solvent when the master batch or resin is dissolved or dispersed in the organic solvent. Alternatively, the charge-controlling agent may be fixed on surfaces of toner base particles after producing the toner base particles.

### —Flowability Improving Agent—

The flowability improving agent is not particularly limited, provided that the flowability improving agent is an agent used to perform a surface treatment to increase hydrophobicity to prevent degradation of flowability and charging properties even in a high humidity environment. The flowability improving agent may be appropriately selected in accordance with the intended purpose. Examples of the flowability improving agent include a silane coupling agent, a silylating agent, a fluoroalkyl group-containing silane coupling agent, an organic titanate-based coupling agent, an aluminium-based coupling agent, silicone oil, and modified silicone oil.

The silica and the titanium oxide are particularly preferably subjected to a surface treatment with any of the above-listed flowability improving agents to be used as hydrophobic silica and hydrophobic titanium oxide.

### —Cleaning Improving Agent—

The cleaning improving agent is not particularly limited, provided that the cleaning improving agent is an agent added to the toner for removing the residual developer on a photoconductor or a primary transfer medium after transferring. The cleaning improving agent may be appropriately selected in accordance with the intended purpose. Examples of the cleaning improving agent include: fatty acid (e.g., stearic acid) metal salts, such as zinc stearate, and calcium stearate; and polymer particles produced by soap-free emulsion polymerization, such as polymethyl methacrylate particles, and polystyrene particles.

The polymer particles are preferably polymer particles having a relatively narrow particle size distribution, and are suitably polymer particles having the volume average particle diameter of from 0.01 μm through 1 μm.

### —Magnetic Material—

The magnetic material is not particularly limited, and may be appropriately selected in accordance with the intended purpose. Examples of the magnetic material include iron powder, magnetite, and ferrite. Among the above-listed examples, white magnetic materials are preferable in view of color tone.

A glass transition temperature (Tg1st) of the toner measured from first heating of differential scanning calorimetry (DSC) is preferably from 40° C. through 65° C.

A glass transition temperature (Tg1st) of the tetrahydrofuran (THF) insoluble component of the toner measured from the first heating of DSC is preferably from −45° C. through 5° C.

A glass transition temperature (Tg2nd) of the THF soluble component of the toner measured from second heating of DSC is preferably from 20° C. through 65° C.

The glass transition temperature (Tg1st) of the toner measured from the first heating of differential scanning calorimetry (DSC) and the glass transition temperature (Tg2nd) of the toner measured from the second heating of DSC preferably satisfy the relation represented by Tg1st−Tg2nd≥10[° C.], because low-temperature fixability and heat-resistant storage stability of a resulting toner improve.

The glass transition temperature of the toner can be measured, for example, by means of a differential scanning calorimeter (DSC-60, available from Shimadzu Corporation).

For example, DSC curves are measured by the differential scanning calorimeter. The DSC curve for the first heating is selected from the obtained DSC curves using an analysis program, and the glass transition temperature Tg1st of the first heating is determined using an endothermic shoulder temperature stored in the analysis program. The DSC curve for the second heating is selected, and the glass transition temperature Tg2nd of the second heating is determined using the endothermic shoulder temperature.

### (Developer)

The developer of the present disclosure includes at least the toner of the present disclosure, and may further include appropriately selected other components, such as a carrier, according to the necessity. The developer may be a one-component developer or two-component developer. In the case where the developer is used for high-speed printers that can correspond to improved information processing speed of recent years, the developer is preferably a two-component developer because service life of the developer improves.

### <Carrier>

The carrier is not particularly limited, and may be appropriately selected in accordance with the intended purpose. The carrier is preferably a carrier including carrier particles each of which includes a core particle and a resin layer covering the core particle.

### —Core Particles—

A material of the core particles is not particularly limited, and may be appropriately selected in accordance with the intended purpose. Examples of the core material include a manganese-strontium-based material of from 50 emu/g through 90 emu/g, and a manganese-magnesium-based material of from 50 emu/g through 90 emu/g. In order to assure adequate image density, moreover, a hard-magnetic material, such as iron powder of 100 emu/g or greater, and magnetite of from 75 emu/g through 120 emu/g, is preferably used. A soft-magnetic material, such as a copper-zinc-based material of from 30 emu/g through 80 emu/g, is preferably used because an impact of the developer held in the form of a brush against the photoconductor can be reduced, and a high image quality of a resulting image can be assured. The above-listed examples may be used alone or in combination.

The volume average particle diameter of the core particles is not particularly limited and may be appropriately selected in accordance with the intended purpose. The volume average particle diameter of the core particles is preferably from 10 μm through 150 μm, and more preferably from 40 μm through 100 μm. When the volume average particle diameter of the core particles is less than 10 μm, a proportion of fine particles to the entire amount of the core particles increases, and the increased proportion of the fine particles, in turn, reduces magnification per particle, consequently causing carrier scattering. When the volume average particle diameter is greater than 150 μm, specific surface areas of the carrier particles reduce, and the reduction in the specific surface areas leads to toner scattering, which may impair reproducibility of a solid image, especially for formation of a full-color image including a large area of a solid image.

The toner of the present disclosure may be mixed with the carrier to be used as a two-component developer.

An amount of the carrier in the two-component developer is not particularly limited, and may be appropriately selected in accordance with the intended purpose. The amount of the carrier is preferably from 90 parts by mass through 98 parts by mass, and more preferably from 93 parts by mass through 97 parts by mass, relative to 100 parts by mass of the two-component developer.

The developer of the present disclosure is suitably used for image formation according to various electrophotographic methods known in the art, such as a magnetic one-component developing method, a non-magnetic one-component developing method, and a two-component developing method.

### (Toner Production Method)

A toner production method of the present disclosure is a method for producing the above-described toner of the present disclosure.

The toner production method includes formation of composite particles, and removing, and may further include other processes according to the necessity.

### <Formation of Composite Particles>

The formation of composite particles includes depositing resin particles on a surface of each of toner base particles to form composite particles.

Examples of a method of forming the composite particles include a known dissolution suspension method where an oil phase including constituent materials of the toner base particles, such as the binder resin, the colorant, and the release agent, is dispersed in an aqueous medium including resin particles to form composite particles.

As one example of the dissolution suspension method, a method of forming composite particles while synthesizing a polyester resin through an elongation reaction and/or cross-linking reaction between the prepolymer and the curing agent will be described.

In this method, preparation of an aqueous medium, preparation of an oil phase including constituent materials of toner base particles, emulsification and/or dispersion of the toner base particles, and removal of the organic solvent are performed.

### —Preparation of Aqueous Medium (Aqueous Phase)—

The preparation of the aqueous medium can be performed by dispersing resin particles in an aqueous medium. An amount of the resin particles added to the aqueous medium is not particularly limited and may be appropriately selected in accordance with the intended purpose. The amount of the resin particles is preferably from 0.5 parts by mass through 10 parts by mass, relative to 100 parts by mass of the aqueous medium.

The aqueous medium is not particularly limited and may be appropriately selected in accordance with the intended purpose. Examples of the aqueous medium include water, a solvent miscible with water, and a mixture of water and a solvent miscible with water. The above-listed examples may be used alone or in combination. Among the above-listed examples, water is preferable.

The solvent miscible with water is not particularly limited, and may be appropriately selected in accordance with the intended purpose. Examples of the solvent miscible with water include alcohol, dimethylformamide, tetrahydrofuran, cellosolves, and lower ketones. Examples of the alcohol include methanol, isopropanol, and ethylene glycol. Examples of the lower ketones include acetone, and methyl ethyl ketone.

### —Preparation of Oil Phase—

The preparation of the oil phase is performed by dissolving and/or dispersing, in an organic solvent, constituent materials of toner base particles, where the constituent materials include a binder resin, a colorant, a release agent, and optionally a curing agent.

The organic solvent is not particularly limited, and may be appropriately selected in accordance with the intended purpose. The organic solvent is preferably an organic solvent having a boiling point of lower than 150° C. because such an organic solvent is easily removed.

Examples of the organic solvent having a boiling point of lower than 150° C. include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. The above-listed examples may be used alone or in combination. Among the above-listed examples, ethyl acetate, toluene, xylene, benzene, methylene chloride, 1,2-dichloroethane, chloroform, and carbon tetrachloride are preferable, and ethyl acetate is more preferable.

—Emulsifying and/or Dispersing—

The emulsifying and/or dispersing the constituent materials of the toner base particles can be performed by dispersing the oil phase including the constituent materials of the toner base particles in the aqueous medium. When the constituent materials are emulsified and/or dispersed, the curing agent and the prepolymer are allowed to react through an elongation reaction and/or cross-linking reaction.

The reaction conditions for generating the prepolymer (e.g., reaction duration and a reaction temperature) are not particularly limited, and may be appropriately selected depending on a combination of the curing agent and the prepolymer. The reaction duration is preferably from 10 minutes through 40 hours, and more preferably from 2 hours through 24 hours. The reaction temperature is preferably from 0° C. through 150° C., and more preferably from 40° C. through 98° C.

A method of stably forming a dispersion liquid including the prepolymer in the aqueous medium is not particularly limited and may be appropriately selected in accordance with the intended purpose. Examples of the method include a method where the oil phase prepared by dissolving and/or dispersing the constituent materials of the toner base particles is added to the aqueous medium, and the resulting mixture is dispersed with shearing force.

A disperser used for the dispersing is not particularly limited and may be appropriately selected in accordance with the intended purpose. Examples of the disperser include a low-speed shearing disperser, a high-speed shearing disperser, a friction disperser, a high-pressure jet disperser, and an ultrasonic disperser. Among the above-listed examples, a high-speed shearing disperser is preferable as the particle diameter of the dispersed elements (i.e., oil droplets) can be adjusted to a range from 2 μm to 20 μm.

In the case where the high-speed shearing disperser is used, conditions, such as rotational speed, a dispersion time, and a dispersion temperature, are appropriately selected in accordance with the intended purpose. The rotational speed is preferably from 1,000 rpm through 30,000 rpm, and more preferably from 5,000 rpm through 20,000 rpm. In case of a batch system, the dispersion duration is preferably from 0.1 minutes through 5 minutes. The dispersion temperature is preferably from 0° C. through 150° C., and more preferably from 40° C. through 98° C. under pressure. Generally speaking, dispersion is performed easier when the dispersion temperature is a high temperature.

An amount of the aqueous medium used for emulsifying or dispersing the constituent components of the toner base particles (may be also referred to as the “toner materials”) is not particularly limited, and may be appropriately selected in accordance with the intended purpose. The amount of the aqueous medium is preferably from 50 parts by mass through 2,000 parts by mass, and more preferably from 100 parts by mass through 1,000 parts by mass, relative to 100 parts by mass of the toner materials.

When the amount of the aqueous medium is less than 50 parts by mass, the toner materials may not be desirably dispersed, consequently not being able to form toner base particles having desired particle diameters. When the amount of the aqueous medium is greater than 2,000 parts by mass, production cost may increase.

When the oil phase including the toner materials is emulsified or dispersed, a dispersing agent is preferably used for stabilizing dispersed elements (e.g., oil droplets) to make particles having desired shapes and a sharp particle size distribution.

The dispersing agent is not particularly limited, and may be appropriately selected in accordance with the intended purpose. Examples of the dispersing agent include a surfactant, a poorly water-soluble inorganic compound dispersing agent, and a polymer-based protective colloid. The above-listed examples may be used alone or in combination. Among the above-listed examples, a surfactant is preferable.

The surfactant is not particularly limited and may be appropriately selected in accordance with the intended purpose. For example, an anionic surfactant, a cationic surfactant, a nonionic surfactant, or an amphoteric surfactant may be used. Examples of the anionic surfactant include an alkyl benzene sulfonic acid salt, an α-olefin sulfonic acid salt, and a phosphoric acid ester. Among the above-listed examples, a fluoroalkyl group-containing surfactant is preferable.

### —Removal of Organic Solvent—

A method of removing the organic solvent from the dispersion liquid, such as the emulsified slurry, is not particularly limited and may be appropriately selected in accordance with the intended purpose. Examples of the method include: a method where the entire reaction system is gradually heated to evaporate the organic solvent inside the oil droplets; and a method of spraying the dispersion liquid in a dry atmosphere to remove the organic solvent in the oil droplets.

Once the organic solvent is removed, composite particles are formed.

### <Removing>

The removing includes removing at least part of the resin particles from the composite particles, and preferably removing part of or all of the shell resin (resin (b1)) of the resin particles.

Examples of the removing part of or all of the resin particles include washing the composite particles. Therefore, the removing can be also referred to as washing.

Examples of a method of removing part of or all of the resin (b1) with the washing include a method where part of or all of the resin (b1) is removed by a chemical method.

Examples of the chemical method include washing the composite particles with a basic aqueous solution. Part of or all of the shell resin (b1) can be dissolved by washing the composite particles with the basic aqueous solution.

The basic aqueous solution is not particularly limited, provided that the aqueous solution is basic. The basic aqueous solution may be appropriately selected in accordance with the intended purpose. Examples of the basic aqueous solution include an aqueous solution of a hydroxide of an alkali metal (e.g., potassium hydroxide and sodium hydroxide) and ammonia. The above-listed examples may be used alone, or in combination.

Among the above-listed examples, potassium hydroxide and sodium hydroxide are preferable as the shell resin (b1) is easily dissolved.

The pH of the basic aqueous solution is preferably from 8 through 14, and more preferably from 10 through 12.

Mixing the composite particles with the alkali aqueous solution during the washing can be performed by a method where the basic aqueous solution is added to a composite slurry by dripping with stirring.

After dripping the basic aqueous solution, an acid aqueous solution may be added by dripping to neutralize.

### <Other Processes>

The above-mentioned other processes are not particularly limited, and may be appropriately selected in accordance with the intended purpose. Examples of the above-mentioned other processes include drying and classifying.

The drying is not particularly limited, provided that the solvent can be removed from the composite particles by the drying. The drying may be appropriately selected in accordance with the intended purpose.

The classifying may be performed by removing the fine particle component by cyclone in a liquid, a decanter, or centrifugation. Alternatively, the classification may be performed after drying.

The obtained composite particles may be mixed with particles of the external additive or the charge controlling agent. As mechanical impacts are applied to the resulting particle mixture, detachment of the particles of the external additive etc. from being detached from surfaces of the toner base particles may be minimized.

A method of applying the mechanical impact is not particularly limited and may be appropriately selected in accordance with the intended purpose. Examples of the method include: a method of applying impact force to the mixture using a blade rotated at high speed; and a method where the mixture is added to a high-speed air flow to accelerate the motion of the particles to make the particles crush into one another or to make the particles crush into a suitable impact board.

A device used for the above-described method is not particularly limited, and may be appropriately selected in accordance with the intended purpose. Examples of the device include an angmill (available from HOSOKAWA MICRON CORPORATION), a device obtained by modifying an I-type mill (available from Nippon Pneumatic Mfg. Co., Ltd.) to reduce pulverization air pressure, a hybridization system (available from NARA MACHINERY CO., LTD.), Kryptron System (available from Kawasaki Heavy Industries, Ltd.), and an automatic mortar.

### (Toner Storage Unit)

The toner storage unit of the present disclosure includes a unit configured to store a toner, and the toner of the present disclosure, where the toner is stored in the unit. Examples of an embodiment of the toner storage unit include a toner storage container, a developing device, and a process cartridge.

The toner storage container includes a container in which the toner is stored.

The developing device is a unit that contains the toner and is configured to develop an electrostatic latent image with the toner.

The process cartridge includes at least an image bearer and a developing unit as an integrated body, stores the toner therein, and is detachably mounted in an image forming apparatus. The process cartridge may further include at least one selected from the group consisting a charging unit, an exposing unit, and a cleaning unit.

Next, an embodiment of the toner storage unit is illustrated in FIG. 6. As illustrated in FIG. 6, the toner storage unit of the present disclosure includes a latent image bearer 101 that is mounted inside the toner storage unit. Moreover, the toner storage unit includes a charging device 102, a developing device 104, and a cleaning unit 107. The toner storage unit may further include other units according to the necessity. In FIG. 6, the numerical reference 103 is exposure light emitted from an exposing device, and the numerical reference 105 is recording paper.

As the latent image bearer 101, a latent image bearer identical to an electrostatic latent image bearer in the below-described image forming apparatus may be used. Moreover, an arbitrary charging member is used as the charging device 102.

In the image forming process using the toner storage unit illustrated in FIG. 6, the latent image bearer 101 is charged by the charging device 102 with rotating in the direction depicted in FIG. 6, and exposed to light 103 by an exposing unit (not illustrated) to form an electrostatic latent image corresponding to an exposure image on the surface of the latent image bearer.

The electrostatic latent image is developed with the toner by the developing device 104, and the developed toner image is transferred to recording paper 105 by a transfer roller 108, followed by outputting the recording paper 105. Subsequently, the surface of the latent image bearer after the image transfer is cleaned by the cleaning unit 107, and the charge is eliminated by a charge-eliminating unit (not illustrated). Then, the above-described procedures are repeated again.

### (Image Forming Apparatus and Image Forming Method)

The image forming apparatus of the present disclosure includes the above-described toner storage unit, and further includes at least an electrostatic latent image bearer, an electrostatic latent image forming unit, and a developing unit. The image forming apparatus may further include other units according to the necessity.

The image forming method discussed in connection with the present disclosure includes at least forming an electrostatic latent image, and developing. The image forming method may further include other steps according to the necessity.

### <Electrostatic Latent Image Bearer>

A material, structure, and size of the electrostatic latent image bearer are not particularly limited and may be appropriately selected from materials, structures, and sizes known in the art. Examples of the material of the electrostatic latent image bearer include inorganic photoconductors (e.g., amorphous silicon, and selenium), and organic photoconductors (e.g., polysilane, and phthalo polymethine). Among the above-listed examples, amorphous silicon is preferable considering long service life.

The linear speed of the electrostatic latent image bearer is preferably 300 mm/s or greater.

### <Electrostatic Latent Image Forming Unit and Formation of Electrostatic Latent Image>

The electrostatic latent image forming unit is not particularly limited, provided that the electrostatic latent image forming unit is a unit configured to form an electrostatic latent image on the electrostatic latent image bearer. The electrostatic latent image forming unit may be appropriately selected in accordance with the intended purpose. Examples of the electrostatic latent image forming unit include a unit including a charging member configured to charge a surface of the electrostatic latent image bearer, and an exposing member configured to expose the charged surface of the electrostatic latent image bearer to light to correspond to an image to be formed.

The formation of an electrostatic latent image (i.e., the forming an electrostatic latent image) is not particularly limited, provided that the formation of an electrostatic latent image includes forming an electrostatic latent image on the electrostatic latent image bearer. The formation of an electrostatic latent image may be appropriately selected in accordance with the intended purpose. For example, the formation of an electrostatic latent image can be performed by charging a surface of the electrostatic latent image bearer, followed by exposing the charged surface of the electrostatic latent image bearer to light to correspond to an image to be formed. The formation of an electrostatic latent image can be performed by the electrostatic latent image forming unit.

### —Charging Member and Charging—

The charging member is not particularly limited, and may be appropriately selected in accordance with the intended purpose. Examples of the charging member include: contact chargers known in the art, each equipped with a conductor or semiconductor roller, brush, film, or rubber blade; and non-contact chargers utilizing corona discharge, such as corotron, and scorotron.

For example, the charging can be performed by applying voltage to the surface of the electrostatic latent image bearer using the charging member.

A form of the charging member may be any shape, such as a magnetic brush and a fur brush, other than a roller. The form of the charging member may be selected depending on specifications or an embodiment of the image forming apparatus.

The charging member is not limited to the contact charger, but the contact charger is preferably used because a resulting image forming apparatus using the contact charger discharges a reduced amount of ozone that is generated from the charging member.

### <<Exposing Member and Exposing>>

The exposing member is not particularly limited, provided that the exposing member is a member capable of exposing the surface of the electrostatic latent image bearer, which has been charged by the charging member, to light to correspond to an image to be formed. The exposing member may be appropriately selected in accordance with the intended purpose. Examples of the exposing member include various exposing members, such as copy optical exposing members, rod lens array exposing members, laser optical exposing members, and liquid crystal shutter optical exposing members.

A light source used for the exposing member is not particularly limited, and may be appropriately selected in accordance with the intended purpose. Examples of the light source include general light emitters, such as a fluorescent lamp, a tungsten lamp, a halogen lamp, a mercury lamp, a sodium vapor lamp, a light emitting diode (LED), a semiconductor laser (LD), and an electroluminescent light (EL).

For applying only light having a desired wavelength range, various filters, such as a sharp-cut filter, a band-pass filter, a near infrared ray-cut filter, a dichroic filter, an interference filter, and a color temperature conversion filter, may be used.

For example, the exposure may be performed by exposing the surface of the electrostatic latent image bearer to light to correspond to an image to be formed using the exposing member.

In the present disclosure, a back-exposure system may be employed. The back-exposure system is a system where the back side of the electrostatic latent image bearer is exposed to light to correspond to an image to be formed.

### <Developing Unit and Developing>

The developing unit is not particularly limited, provided that the developing unit stores a toner and is configured to develop the electrostatic latent image formed on the electrostatic latent image bearer with the toner to form a visible image. The developing unit may be appropriately selected in accordance with the intended purpose.

The developing is not particularly limited, provided that the developing includes developing the electrostatic latent image formed on the electrostatic latent image bearer with a toner to form a toner image that is a visible image. The developing may be appropriately selected in accordance with the intended purpose. For example, the developing may be performed by the developing unit.

The developing unit is preferably a developing device including a stirring rod configured to stir the toner to charge the toner with friction, and a developer bearing member, inside of which a magnetic field generating unit is disposed and fixed, where the developer bearing member is rotatably disposed and is configured to bear a developer including the toner on a surface of the developer bearing member.

### <Other Units and Other Processes>

Examples of the above-mentioned other units include a transferring unit, a fixing unit, a cleaning unit, a charge-eliminating unit, a recycling unit, and a controlling unit.

Examples of the above-mentioned other processes include transferring, fixing, cleaning, charge eliminating, recycling, and controlling.

### —Transferring Unit and Transferring—

The transferring unit is not particularly limited, provided that the transferring unit is a unit configured to transfer the visible image to a recording medium. The transferring unit may be appropriately selected in accordance with the intended purpose. A preferable embodiment of the transferring unit is a transferring unit including a primary transferring unit configured to transfer visible images onto an intermediate transfer member to form a composite transfer image, and a secondary transferring unit configured to transfer the composite transfer image onto a recording medium.

The transferring is not particularly limited, provided that the transferring includes transferring the visible image to a recording medium. The transferring may be appropriately selected in accordance with the intended purpose. A preferable embodiment of the transferring is transferring using an intermediate transfer member, where the transferring includes primary transferring visible images onto the intermediate transfer member, followed by secondary transferring the visible images onto the recording medium.

For example, the transferring can be performed by charging the photoconductor with a transfer charger to charge the visible image. The transferring may be performed by the transferring unit.

When an image secondary transferred to the recording medium is a color image formed of two or more color toners, images of respective color toners are sequentially superimposed onto the intermediate transfer member by the transferring unit to form a composite image on the intermediate transfer member, and the composite image on the intermediate transfer member is collectively secondary transferred onto the recording medium by the intermediate transferring unit (i.e., the secondary transferring unit).

The intermediate transfer member is not particularly limited and may be appropriately selected from transfer members known in the art in accordance with the intended purpose. Preferable examples of the intermediate transfer member include a transfer belt.

The transferring unit (e.g., the primary transferring unit, and the secondary transferring unit) preferably includes at least a transfer member configured to charge the visible image formed on the photoconductor to release and transfer the visible image towards the side of the recording medium. Examples of the transfer member include a corona transfer member using corona discharge, a transfer belt, a transfer roller, a pressure transfer roller, and an adhesion transfer member.

The recording medium is typically plane paper. The recording medium is not particularly limited, provided that the recording medium is a medium to which an unfixed image after developing can be transferred. The recording medium may be appropriately selected in accordance with the intended purpose. A PET base for an overhead projector (OHP) may be also used as the recording medium.

### —Fixing Unit and Fixing—

The fixing unit is not particularly limited, provided that the fixing unit is a unit configured to fix the image transferred onto the recording medium. The fixing unit may be appropriately selected in accordance with the intended purpose. For example, the fixing unit is preferably a known heat press member. Examples of the heat press member include a combination of a heating roller and a press roller, and a combination of a heating roller, a press roller, and an endless belt.

The fixing is not particularly limited, provided that the fixing includes fixing the visible image transferred onto the recording medium. The fixing may be appropriately selected in accordance with the intended purpose. For example, the fixing may be performed every time an image of each color toner is transferred to the recording medium, or may be performed once after images of all of color toners are superimposed on the recording medium.

The fixing may be performed by the fixing unit.

Heating performed by the heat press member is preferably at a temperature from 80° C. through 200° C.

In the present disclosure, for example, a known optical fixing device may be used in combination with or instead of the fixing unit in accordance with the intended purpose.

The surface pressure applied during the fixing is not particularly limited and may be appropriately selected in accordance with the intended purpose. The surface pressure is preferably from 10 N/cm² through 80 N/cm².

### <<Cleaning Unit and Cleaning>>

The cleaning unit is not particularly limited, provided that the cleaning unit is capable of removing the residual toner on the photoconductor. The cleaning unit may be appropriately selected in accordance with the intended purpose. Examples of the cleaning unit include a magnetic brush cleaner, an electrostatic brush cleaner, a magnetic roller cleaner, a blade cleaner, a brush cleaner, and a web cleaner.

The cleaning is not particularly limited, provided that the cleaning can remove the toner remaining on the photoconductor. The cleaning may be appropriately selected in accordance with the intended purpose. For example, the cleaning can be performed by the cleaning unit.

### —Charge-Eliminating Unit and Charge Eliminating—

The charge-eliminating unit is not particularly limited, provided that the charge-eliminating unit is a unit configured to apply charge-eliminating bias to the photoconductor to eliminate the charge of the photoconductor. The charge-eliminating unit may be appropriately selected in accordance with the intended purpose. Examples of the charge-eliminating unit include a charge-eliminating lamp.

The charge eliminating is not particularly limited, provided that the charge eliminating includes applying charge-eliminating bias to the photoconductor to eliminate the charge of the photoconductor. The charge eliminating may be appropriately selected in accordance with the intended purpose. For example, the charge eliminating may be performed by the charge-eliminating unit.

### —Recycling Unit and Recycling—

The recycling unit is not particularly limited, provided that the recycling unit is a unit configured to recycle the toner removed by the cleaning to the developing device. The recycling unit may be appropriately selected in accordance with the intended purpose. Examples of the recycling unit include known conveying units.

The recycling is not particularly limited, provided that the recycling includes recycling the toner removed by the cleaning to the developing device. The recycling may be appropriately selected in accordance with the intended purpose. For example, the recycling may be performed by the recycling unit.

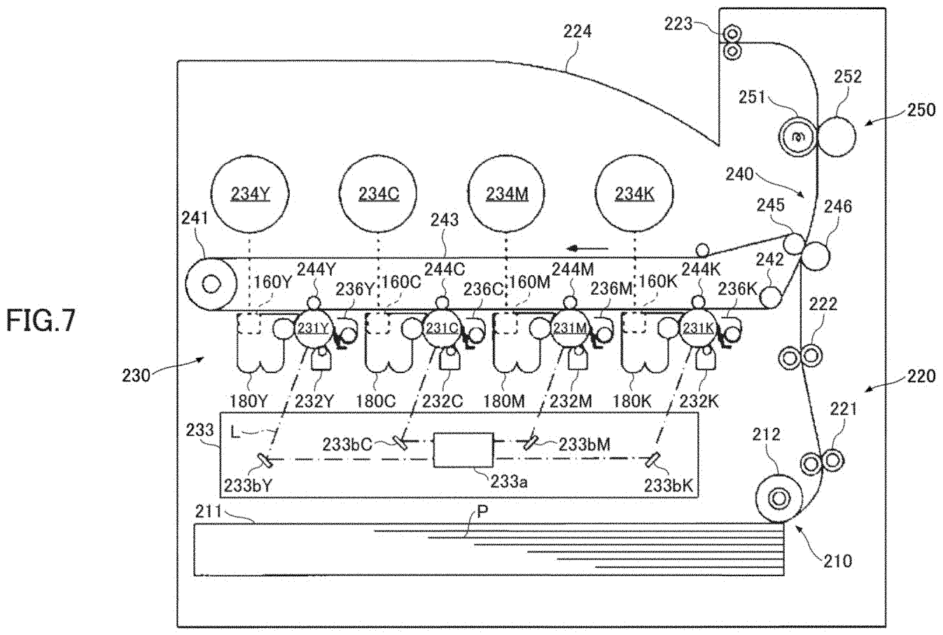

Next, one embodiment for carrying out a method of forming an image by the image forming apparatus of the present disclosure will be described with reference to FIG. 7. A printer is illustrated as an example of the image forming apparatus of the present embodiment, but the image forming apparatus is not particularly limited, provided that the image forming apparatus is an apparatus capable of forming an image with a toner, such as a photocopier, a facsimile, and a multifunction peripheral.

The image forming apparatus includes a paper feeding unit 210, a conveying unit 220, an image formation unit 230, a transferring unit 240, and a fixing unit 250.

The paper feeding unit 210 includes a paper feeding cassette 211 loaded with paper P to be fed, and a paper feeding roller 212 configured to feed paper P from the paper feeding cassette 211 one by one.

The conveying unit 220 includes a roller 221 configured to transport the paper P fed by the paper feeding roller 212 towards the transferring unit 240, a pair of timing rollers 222 configured to nip the edge of the paper P transported by the roller 221 to make the paper P stand-by and send the paper P to the transferring unit 240 at the predetermined timing, and a paper ejection roller 223 configured to discharge the paper P on which a color toner image is fixed to the paper ejection tray 224.

The image formation unit 230 includes an image formation unit Y configured to form an image using a developer including a yellow toner, an image formation unit C using a developer including a cyan toner, an image formation unit M using a developer including a magenta toner, and an image formation unit K using a developer including a black toner, which are disposed in this order along the direction from left to right in FIG. 7 with the predetermined gap between the image forming units next to one another, and an exposure unit 233.

When an arbitrary image formation unit is described among the image formation units (Y, C, M, K), it is simply referred to as an image formation unit.

Moreover, the developer includes the toner and a carrier. The four image formation units (Y, C, M, and K) have identical mechanical structures, except that a developer for use is different.

The transferring unit 240 includes a driving roller 241 and a driven roller 242, an intermediate transfer belt 243 rotatable in the anti-clockwise direction in FIG. 7 along the movement of the driving roller 241, primary transfer rollers (244Y, 244C, 244M, and 244K) disposed to face the photoconductor drum 231 via the intermediate transfer belt 243, and a secondary counter roller 245 and a secondary transfer roller 246 disposed to face each other via the intermediate transfer belt 243 at a position where the toner image is transferred to paper.

The fixing unit 250 includes a press roller 252, in which a heater is disposed. The press roller is configured to rotatably press a fixing belt 251 to form a nip, where the fixing belt 251 is configured to heat the paper P. Owing to the fixing unit, heat and pressure are applied to the color toner image on the paper P to fix the color toner image. The paper P, on which the color toner image has been fixed, is ejected to the paper ejection tray 224 by the paper ejection roller 223, to thereby complete a series of image formation processes.

### EXAMPLES

The present disclosure will be described below by way of Examples. The present disclosure should not be construed as being limited to these Examples. In Examples, “part(s)” denotes “part(s) by mass” and “%” denotes “% by mass” unless otherwise stated.

### Production Example 1

[Production of Resin Particle (A) Aqueous Dispersion Liquid (W0-1)]

A reaction vessel equipped with a stirrer, a heating and cooling device, and a thermometer was charged with 3,710 parts by mass of water and 200 parts of polyoxyethylene-1-(allyloxymethyl)alkyl ether ammonium sulfate (HITENOL KH-1025, available from DKS Co., Ltd.), and the resulting mixture was stirred at 200 rpm to homogenize the mixture. The temperature of the internal temperature was increased to 75° C. to heat the homogenized mixture. Thereafter, 90 parts of a 10% by weight ammonium persulfate aqueous solution was added, followed by adding a mixture including 450 parts of styrene, 250 parts of butyl acrylate, and 300 parts of methacrylic acid by dripping over the course of 4 hours.

After the dripping, the resulting product was matured for 4 hours at 75° C., to thereby obtain an aqueous dispersion liquid (W0-1) of resin particles (A-1) including the resin (a1-1) that was a polymer obtained by copolymerizing the monomers and the polyoxyethylene-1-(allyloxymethyl)alkyl ether ammonium sulfate.

The volume average particle diameter of the particles in the particle aqueous dispersion liquid (W0-1) was measured by dynamic light scattering (an electrophoretic light scattering device, ELS-8000, available from Otsuka Electronics Co., Ltd.). As a result, the volume average particle diameter was 15 nm.

Part of the particle aqueous dispersion liquid (W0-1) was dried to separate the resin (a1-1). The separated resin component had a glass transition temperature (Tg) of 53° C. and an acid value of 195 mgKOH/g.

The present disclosure can be achieved by use of the resin particles A and the resin particles B in combination. Since the resin particle B could be produced in the same manner as the resin (a1-1), the resin (a1-1) was also used as resin particles B-1.

### Production Example 2

[Production of Resin Particle (A) Aqueous Dispersion Liquid (W0-2)]

A reaction vessel equipped with a stirrer, a heating and cooling device, and a thermometer was charged with 3,760 parts by mass of water and 150 parts by mass of polyoxyethylene-1-(allyloxymethyl)alkyl ether ammonium sulfate (HITENOL KH-1025, available from DKS Co., Ltd.), and the resulting mixture was stirred at 200 rpm to homogenize the mixture. The homogenized mixture was heated to increase the internal system temperature to 75° C. Thereafter, 90 parts of a 10% by weight ammonium persulfate aqueous solution was added, followed by adding a mixture including 430 parts by mass of styrene, 270 parts by mass of butyl acrylate, and 300 parts by mass of methacrylic acid by dripping over the course of 4 hours.

After the dripping, the resulting product was matured for 4 hours at 75° C., to thereby acquire a particle dispersion liquid (W0-2) of resin particles including the resin (a1-2) that was a polymer obtained by copolymerizing the monomers and the polyoxyethylene-1-(allyloxymethyl)alkyl ether ammonium sulfate.

The volume average particle diameter of the particles in the particle aqueous dispersion liquid (W0-2) was measured in the same manner as in Production Example 1. As a result, the volume average particle diameter was 30 nm.

Part of the particle aqueous dispersion liquid (W0-2) was dried to separate the resin (a1-2). The separated resin component had a glass transition temperature (Tg) of 53° C., and an acid value of 195 mgKOH/g.

The present disclosure can be achieved by use of the resin particles A and the resin particles B in combination. Since the resin particle B could be produced in the same manner as the resin (a1-2), the resin (a1-2) was also used as resin particles B-2, similarly to Production Example 1.

Next, the details of the resin particle (A) aqueous dispersion liquids (W0-1) and (W0-2) are summarized in Table 1.

TABLE 1

| | Resin particle (A) | |
|---|---|---|
| | aqueous dispersion | |
| | liquid | |
| Components (parts by mass) | W0-1 | W0-2 |
| Water | 3,710 | 3,760 |
| Polyoxyethylene-1- | 200 | 150 |
| (allyloxymethyl)alkyl ether | | |
| ammonium sulfate | | |
| (HITENOL KH-1025, available from | | |
| DKS Co., Ltd.) | | |
| 10% by mass ammonium persulfate | 90 | 90 |
| aqueous solution | | |
| Styrene | 450 | 430 |
| Butyl acrylate | 250 | 270 |
| Methacrylic acid | 300 | 300 |
| Volume average particle diameter | 15 | 30 |
| Glass transition temperature (° C.) | 53 | 53 |
| Acid value (mgKOH/g) | 195 | 195 |

### Production Example 3

### <Production of Resin Particle (A-1) Aqueous Dispersion Liquid (W-1)>

Next, a reaction vessel equipped with a stirrer, a heating and cooling device, and a thermometer was charged with 667 parts by mass of the resin particle (A) dispersion liquid (W0-1) and 248 parts by mass of water. To the resulting mixture, 0.267 parts by mass of tert-butyl hydroperoxide (PERBUTYL H, available from NOF CORPORATION) was added, and the resulting mixture was heated to increase the internal system temperature to 70° C. To the heated mixture, thereafter, 43.3 parts by mass of styrene, 23.3 parts by mass of butyl acrylate, and 18.0 parts by mass of a 1% by mass ascorbic acid aqueous solution were added by dripping over the course of 2 hours.

After the dripping, the resulting mixture was matured for 4 hours at 70° C., to thereby obtain an aqueous dispersion liquid (W-1) of resin particles (A-1) including, as constituent materials, a resin (a2-1) and a resin (a1-1) in each particle, where the resin (a2-1) was a polymer obtained by copolymerizing the monomers using the resin particles in the aqueous dispersion liquid (W0-1) as seeds.

The volume average particle diameter of the resin particles (A-1) was measured in the same manner as in Production Example 1. As a result, the volume average particle diameter was 17.3 nm.

The resin particle (A-1) aqueous dispersion liquid (W-1) was neutralized with a 10% by mass ammonia solution to be pH 9.0. The resulting dispersion liquid was subjected to centrifuge separation. The separated sediment was dried and solidified to thereby separate the resin (a2-1). The separated resin (a2-1) had a glass transition temperature (Tg) of 53° C.

Whether or not the resin particle (A-1) aqueous dispersion liquid (W-1) included the resin particles (A-1) including, as constituent materials, the resin (a1-1) and the (a2-1) in each particle was confirmed in the following manner.

Specifically, 2 parts by mass of gelatin (Cook Gelatin, available from MORINAGA & CO., LTD.) was added to and dissolved in 15 parts of water heated to a temperature of from 95° C. through 100° C. To the gelatin aqueous solution, which had been air-cooled to 40° C., the aqueous dispersion liquid (W-1) was blended at a mass ratio of 1:1. After sufficiently stirring the resulting mixture, the mixture was cooled at 10° C. for 1 hour to set to form a gel.

The gel was cut by means of ultramicrotome (Ultramicrotome UC7, FC7, available from Leica Microsystems) with controlling a temperature at −80° C. to produce a cut piece having a thickness of 80 nm. Then, the cut piece was dyed with a vapor phase of a 2% ruthenium tetroxide aqueous solution for 5 minutes. The dyed cut piece was observed under a transmission electron microscope (H-7100, available from Hitachi High-Tech Corporation) to confirm the presence of the resin (a2-1) and the resin (a1-1) in each particle.

### Production Example 4

### <Production of Resin Particle (A-2) Aqueous Dispersion Liquid (W-2)>

Next, a reaction vessel equipped with a stirrer, a heating and cooling device, and a thermometer was charged with 667 parts by mass of the resin particle (A) dispersion liquid (W0-2) and 248 parts by mass of water. To the resulting mixture, 0.267 parts by mass of tert-butyl hydroperoxide (PERBUTYL H, available from NOF CORPORATION) was added, and the resulting mixture was heated to increase the internal system temperature to 70° C. To the heated mixture, thereafter, 43.3 parts by mass of styrene, 23.3 parts by mass of butyl acrylate, and 18.0 parts by mass of a 1% by mass ascorbic acid aqueous solution were added by dripping over the course of 2 hours.

After the dripping, the resulting mixture was matured for 4 hours at 70° C., to thereby obtain an aqueous dispersion liquid (W-2) of resin particles (A-2) including, as constituent materials, a resin (a2-2) and a resin (a1-2) in each particle, where the resin (a2-2) was a polymer obtained by copolymerizing the monomers using the resin particles in the aqueous dispersion liquid (W0-2) as seeds.

The volume average particle diameter of the resin particles (A-2) was measured in the same manner as in Production Example 1. As a result, the volume average particle diameter was 34.3 nm.

The resin particle (A-2) aqueous dispersion liquid (W-2) was neutralized with a 10% by mass ammonia solution to be pH 9.0. The resulting dispersion liquid was subjected to centrifuge separation. The separated sediment was dried and solidified to thereby separate the resin. A glass transition temperature (Tg) of the resin (a2-2) was 53° C.

Whether or not the resin particles (A-2) of the aqueous dispersion liquid (W-2) included, as constituent materials, the resin (a1-2) and the resin (a2-2) in each particle was confirmed in the same manner as in Production Example 3.

Next, the details of the resin particles (A-1) and (A-2) are summarized in Tables 2-1 and 2-2.

TABLE 2-1

| | | | | | | | 1% by mass |
|---|---|---|---|---|---|---|---|
| | | Particle | | | | | ascorbic acid |
| | | dispersion | | t-butyl | | Butyl | aqueous |
| Resin | Particle | liquid | Water | peroxide | Styrene | acrylate | solution |
| particle | dispersion | (parts | (parts | (parts | (parts | (parts | (parts |
| No. | liquid | by mass) | by mass) | by mass) | by mass) | by mass) | by mass) |
| A-1 | W0-1 | 667 | 248 | 0.267 | 43.3 | 23.3 | 18 |
| A-2 | W0-2 | 667 | 248 | 0.267 | 43.3 | 23.3 | 18 |

TABLE 2-2

| | | Volume | |
|---|---|---|---|
| | | average | |
| Resin | Particle | particle | |
| particle | dispersion | diameter | Tg |
| No. | liquid | (nm) | (° C.) |
| A-1 | W0-1 | 17.3 | 53 |
| A-2 | W0-2 | 34.3 | 53 |

### (Production of External Additive)

External Additives A to C were each produced by blending primary particles having the volume average particle diameter and a treatment agent presented in Table 3-1 by a spray dryer, and firing under the conditions presented in Table 3-1 to cohere the primary particles.

The treating agent was prepared by adding 0.1 parts by mass of a treatment aid (i.e., water or a 1% by mass acetic acid aqueous solution) to 1 part by mass of methyltrimethoxysilane. The volume average particle diameter and shapes of the secondary particles produced with cohesion of the primary particles are presented in Table 3-2.

### (Production of Carrier for Evaluating External Additive)

The following raw materials of a carrier were dispersed by means of a homomixer for 10 minutes to obtain a coating liquid for an alumina particle-containing acrylic resin/silicone resin coating layer. The coating liquid was applied to a fired ferrite powder [(MgO)1.8 (MnO)49.5 (Fe₂O3)48.0, weight average particle diameter: 25 μm] serving as core particles by means of SPIRACOATER (available from OKADA SEIKO CO., LTD.) in a manner that a thickness of the coating liquid on a surface of each core particle was to be 0.15 μm, followed by drying, to obtain a coated ferrite powder. The obtained coated ferrite powder was left to stand in an electric furnace at 150° C. for 1 hour to fire the coated ferrite powder. After cooling the resulting ferrite powder, bulks of the ferrite powder were crushed using a sieve having an opening size of 106 μm, to thereby obtain a carrier. A film thickness was measured by observing a cross-section of the carrier particle under a transmission electron microscope to observe the coating layer covering the surface of the carrier particle. The average value of the thicknesses of the coating layers was determined as the thickness of the coating layer. In the manner as described above, a carrier having the weight average particle diameter of 35 μm, which was used for evaluating an external additive, was obtained.

### [Raw Materials of Carrier Used for Evaluation of External Additive]

Acrylic resin solution (solid content: 50%): 21.0 parts by mass
Guanamine resin solution (solid content: 70%): 6.4 parts by mass
Alumina particles (0.3 μm, specific electric resistance: 10¹⁴ Ω·cm): 7.6 parts by mass
Silicone resin solution (solid content: 23%): 65.0 parts by mass [SR2410, available from Dow Toray Co., Ltd.]
Aminosilane coupling agent (solid content: 100%): 1.0 parts by mass [SH6020, available from Dow Toray Co., Ltd.]
Toluene: 60.0 parts by mass
Butyl cellosolve: 60.0 parts by mass

### (Evaluation of Cracking or Breakage of External Additive)

A developer (50 g) including 0.5 g of one of External Additives A to C and 49.5 g of the carrier for evaluating an external additive placed in a 50 mL bottle (available from NICHIDEN-RIKA GLASS CO., LTD.) was stirred by means of a rocking mill (available from Seiwa Giken Co., Ltd.) for 3 minutes at 67 Hz. The stirred developer was diluted with and dispersed in tetrahydrofuran (THF) to separate the external additive to move towards the side of the supernatant, followed by observing the external additive under a field emission scanning electron microscope (FE-SEM).

A proportion (%) of primary particles per 1,000 particles of the external additives was determined by the FE-SEM observation. FIG. 3 is a photograph depicting a measurement result that the proportion of the primary particles was 30% or less. FIG. 4 is a photograph depicting a measurement result that the proportion of the primary particles was greater than 30%. As indicated with the numerical reference 4 in FIGS. 3 and 4, particles that were not cohered to one another were counted as “primary particles” to determine the proportion thereof during the measurement.

TABLE 3-1

| | Production of external additive | | | | | | |
|---|---|---|---|---|---|---|---|
| | | | | production conditions | | | |
| | | | | | primary | | |
| | | | | | particles/ | | |
| | primary particles | | | | treating agent | firing | firing |
| | | Dv X | proportion | treating | blending ratio | temperature | duration |
| | type | (nm) | (%) | agent | (mass ratio) | (° C.) | (h) |
| External | silica | 70 | 16 | MeSi(Ome)₃ | 100/10 | 800 | 16 |
| additive A | | | | | | | |
| External | silica | 110 | 29 | MeSi(Ome)₃ | 100/10 | 800 | 8 |
| additive B | | | | | | | |
| External | silica | 70 | 34 | MeSi(Ome)₃ | 100/10 | 400 | 8 |
| additive C | | | | | | | |

TABLE 3-2

| | Production of external | | |
|---|---|---|---|
| | additive | | |
| | secondary | | degree |
| | particles | | of |
| | Dv | | cohesion |
| | Y(nm) | shapes | X/Y |
| External | 160 | non- | 2.29 |
| additive A | | spherical | |
| External | 296 | non- | 2.69 |
| additive B | | spherical | |
| External | 168 | non- | 2.40 |
| additive C | | spherical | |

### Production Example 5

<Synthesis of Amorphous Polyester Resin (b-1)>

A reaction vessel equipped with a cooling tube, a stirrer, a heating and cooling device, a thermometer, and a nitrogen inlet tube was charged with 425 parts by mass of a bisphenol A-PO (2 mol) adduct, 100 parts by mass of propylene glycol, 634 parts by mass of a terephthalic acid-propylene glycol (2 mol) adduct, and 0.5 parts by mass of titanium diisopropoxybis(triethanolaminate) serving as a condensation catalyst. The resulting mixture was allowed to react for 12 hours at 230° C.

Subsequently, the resulting product was further allowed to react under the reduced pressure of from 10 mmHg through 15 mmHg.

The amount of the collected propylene glycol was 195 parts by mass.

Subsequently, the resulting product was cooled to 180° C., followed by adding 30 parts by mass of trimellitic anhydride. The mixture was allowed to react for 1 hour at 180° C., followed by collecting the reaction product.

The collected resin was cooled to room temperature, to thereby obtain an amorphous polyester (b-1). The amorphous polyester resin component had a glass transition temperature (Tg) of 42° C., a number average molecular weight (Mn) of 2,400, a weight average molecular weight (Mw) of 5,400, a hydroxyl value of 32 mgKOH/g, and an acid value of 18 mgKOH/g.

### Production Example 6

### <Production of Colorant Dispersion Liquid>

A reaction vessel equipped with a cooling tube, a stirrer, a heating and cooling device, a thermometer, and a nitrogen-inlet tube was charged with 557 parts by mass of propylene glycol, 569 parts by mass of dimethyl terephthalate, 184 parts by mass of adipic acid, and 3 parts by mass of tetrabutoxy titanate serving as a condensation catalyst. The resulting mixture was allowed to react for 8 hours at 180° C. under nitrogen flow, with removing methanol generated.

Subsequently, the reaction mixture was further reacted for 4 hours under nitrogen flow while gradually heating to 230° C. and removing propylene glycol and water generated. The reaction mixture was yet further reacted for 1 hour under the reduced pressure of from 0.007 MPa through 0.026 MPa.

The amount of the collected propylene glycol was 175 parts by mass.

Subsequently, the resulting reaction mixture was cooled to 180° C., followed by adding 121 parts of trimellitic anhydride. The resulting mixture was allowed to react for 2 hours under atmospheric pressure in a sealed condition, followed by heating to 220° C. under atmospheric pressure. The reaction was continued until a softening point of the reaction product was to be 180° C., to thereby obtain a polyester resin (number average molecular weight (Mn)=8,500).

A beaker was charged with 20 parts by mass of copper phthalocyanine, 4 parts by mass of a dispersing agent (SOLSPERSE 28000, available from The Lubrizol Corporation), 20 parts by mass of the polyester resin, and 56 parts by mass of ethyl acetate. The resulting mixture was stirred to homogeneously disperse the materials, followed by finely dispersing the copper phthalocyanine by means of a bead mill, to thereby acquire a colorant dispersion liquid.

A volume average particle diameter of the particles in the colorant dispersion liquid was 0.2 μm.

### Production Example 7

<Production of Modified Wax (d)>

A pressure-resistant reaction vessel equipped with a stirrer, a heating and cooling device, a thermometer, and a gas cylinder for dripping was charged with 454 parts by mass of xylene, and 150 parts of low-molecular weight polyethylene (SANWAX LEL-400, available from SANYO CHEMICAL CO., LTD.). After nitrogen purging, the resultant mixture was heated to 170° C. with stirring. At 170° C., a mixed solution including 595 parts by mass of styrene, 255 parts by mass of methyl methacrylate, 34 parts by mass of di-t-butyl peroxy hexahydro terephthalate, and 119 parts by mass of xylene was added by dripping over the course of 3 hours, and the temperature of the resultant mixture was maintained at 170° C. for 30 minutes.

Subsequently, xylene was removed from the mixture under the reduced pressure of 0.039 MPa to thereby obtain modified wax (d). The SP value of the graft chain of the modified wax (d) was 10.35 (cal/cm³)^{1/2}. Moreover, the modified wax (d) had the number average molecular weight (Mn) of 1,900, the weight average molecular weight (Mw) of 5,200, and a glass transition temperature (Tg) of 57° C.

### Production Example 8

### <Production of Release Agent Dispersion Liquid>

A reaction vessel equipped with a cooling tube, a stirrer, a heating and cooling device, and a thermometer was charged with 10 parts by mass of paraffin wax (HNP-9, available from Nippon Seiro Co., Ltd.), 1 part by mass of the modified wax (d), and 33 parts by mass of ethyl acetate. The resulting mixture was heated to 78° C., followed by stirring for 30 minutes at 78° C. Thereafter, the resulting mixture was cooled down to 30° C. over the course of 1 hour to crystalize and precipitate the paraffin wax into particles. The resulting paraffin wax particles were wet pulverized by ULTRA VISCOMILL (available from AIMEX CO., LTD.), to thereby obtain a release agent dispersion liquid.

The volume average particle diameter of the particles in the release agent dispersion liquid was 0.25 μm.

### Production Example 9

<Production of Reactive Prepolymer (α2b-1)>

A reaction vessel equipped with a cooling tube, a stirrer, a heating and cooling device, a thermometer, and a nitrogen-inlet tube was charged with 439 parts by mass of a bisphenol A-PO (2 mol) adduct, 329 parts by mass of a bisphenol A-PO (3 mol) adduct, 206 parts by mass of terephthalic acid, 90 parts by mass of adipic acid, and 0.5 parts by mass of titanium diisopropoxybis(triethanolaminate) serving as a condensation catalyst. The resulting mixture was allowed to react for 10 hours under the reduced pressure of from 0.5 kPa through 2.5 kPa with gradually heating to 230° C.

When the acid value reached less than 1 mgKOH/g, the reaction product was taken out, to thereby obtain polyester (α2b0-1). The obtained polyester resin component had a glass transition temperature (Tg) of 45° C., a number average molecular weight (Mn) of 3,900, a weight average molecular weight (Mw) of 11,000, and a hydroxyl value of 25 mgKOH/g.

Next, a pressure-resistant reaction vessel equipped with a stirrer, a heating and cooling device, and a thermometer was charged with 448 parts by mass of the polyester (α2b0-1), 52 parts by mass of isophorone diisocyanate, and 500 parts by mass of ethyl acetate. The resulting mixture was allowed to react in a sealed condition for 10 hours at 80° C., to thereby obtain a reactive prepolymer (α2b-1) solution where the prepolymer included an isocyanate group at a terminal of the molecular chain.

The reactive prepolymer (α2b-1) had a urethane group concentration of 2.0, a number average molecular weight (Mn) of 6,900, and a weight average molecular weight (Mw) of 25,000.

### Example 1

### <Production of Composite Resin Particle (C-1)>

A beaker was charged with 165 parts by mass of ion-exchanged water, a mixture including 5 parts by mass of the particle dispersion liquid (W-1) and 10 parts by mass of the particle dispersion liquid (W0-1), 1 part by mass of sodium carboxymethylcellulose, 26 parts by mass of sodium dodecyldiphenyl ether disulfate (ELEMINOL MON-7, available from SANYO CHEMICAL CO., LTD.), and 15 parts by mass of ethyl acetate. The resulting mixture was mixed to obtain a dispersion liquid.

Subsequently, another beaker was charged with 71 parts by mass of the amorphous polyester resin (b-1), 40 parts by mass of the colorant dispersion liquid, 39 parts by mass of the release agent dispersion liquid, and 54 parts by mass of ethyl acetate. After mixing the resulting mixture, 18 parts by mass of the reactive prepolymer (α2b-1) solution, and 0.3 parts by mass of isophorene diamine serving as a curing agent (R) were added. The resulting mixture was mixed to obtain a mixture.

The entire amount of the obtained mixture was added to the previously produced dispersion liquid. The resulting mixture was stirred by means of TK Auto Homomixer for 2 minutes to obtain a mixture.

Next, the obtained mixture was transferred into a reaction vessel equipped with a stirrer and a thermometer. The ethyl acetate was removed from the mixture at 50° C. until the concentration of the ethyl acetate was to be 0.5% by mass or less, to thereby obtain a composite resin particle aqueous dispersion liquid.

The composite resin particles in the composite resin particle aqueous dispersion liquid were composition resin particles where particles including the resin particle (A-1) were deposited on each of the resin particles (B′-1) including the amorphous polyester resin (b-1) and the amorphous crystalline polyester resin (b-2) formed of the reaction product between the reactive prepolymer (α2b-1) and the isophorone diamine.

Whether the resin particles included in the composite resin particle aqueous dispersion liquid were the composite resin particles (C-1), where the resin particles including the resin particles (A-1) were deposited on each of the resin particles (B′-1) was confirmed by magnifying and observing shapes of particles included in the composite resin particle aqueous dispersion liquid using an electron microscope (scanning electron microscope, SU-8230, available from Hitachi High-Tech Corporation).

Next, sodium hydroxide was added to adjust the pH of the composite resin particle aqueous dispersion liquid to 12. The resulting dispersion liquid was stirred by means of a Three-One-Motor for 1 hour. Thereafter, the resulting dispersion liquid was subjected to centrifugal filtration. Ion-exchanged water was added to the filtration cake to form slurry. After repeating processes of performing centrifugal filtration and forming slurry a few times, the resulting slurry was subjected to suction filtration using a membrane filter. This series of processes may be simply referred to as “washing and filtering” hereinafter. The resulting filtration cake was dried for 18 hours at 40° C. to reduce the volatile component to 0.5% by mass or less, to thereby obtain composite resin particles (C-1).

To 100 parts by mass of the composite resin particles (C-1), subsequently, external additives including 1.0 part by mass of colloidal silica (AEROSIL R972, available from NIPPON AEROSIL CO., LTD.) and 2.0 parts by mass of External Additive A were added and mixed by means of a sample mill, to thereby obtain Toner (T-1) after the external additive treatment.

Next, the obtained toner was subjected to a releasing method of the external additives using ultrasonic waves in the following manner to remove the external additives as much as possible to turn the toner particles into a state close to the toner base particles. Then, an average value of distances between the resin particles, and the standard deviation of the distance between the resin particles were determined. As a result, the average value of the distances between the resin particles of Toner (T-1) was 120 nm, and the standard deviation of the distance between the resin particles of Toner (T-1) was 63 nm.

### <Measurement of Distance Between Resin Particles>

### —Releasing Method of External Additive—

[1] A 100 mL screw vial was charged with 50 mL of a 5% by mass surfactant aqueous solution (product name: NOIGEN ET-165, available from DKS Co., Ltd.). To the solution, 3 g of the toner was added, and the vial was gently agitated in up-down and left-right motion. Then, the resulting mixture was stirred by means of a ball mill for 30 minutes to homogeneously disperse the toner in the dispersion liquid.

[2] Then, ultrasonic energy was applied to the resulting dispersion liquid for 60 minutes by means of an ultrasonic homogenizer (product name: Homogenizer, type: VCX750, CV33, available from SONICS & MATERIALS, INC.) with setting the output to 40 W.

### —Ultrasonic Wave Conditions—

Vibration duration: continuous 60 minutes

### Amplitude: 40 W

Vibration onset temperature: 23° C.±1.5° C.
Temperature during vibration: 23° C.±1.5° C.

[3] (1) The dispersion liquid was filtered by vacuum filtration using filter paper (product name: Quantitative filter paper (No. 2, 110 mm), available from Advantec Toyo Kaisha, Ltd.). The resulting filtration cake was washed twice with ion-exchanged water, followed by performing filtration to remove free additive particles. Then, the collected base particles of the toner sample were dried.

(2) The toner obtained in (1) was observed under a scanning electron microscope (SEM). First, a backscattered electron image was observed to detect the external additive and/or filler including Si.

(3) The image of (2) was binarized using image processing software (ImageJ) to eliminate the external additive and/or filler.

Next, the section of the toner identical to the observation section of (2) was observed to acquire a secondary electron image. Since the resin particles were not detected on the backscattered electron image and could be detected only on the secondary electron image, the secondary electron image was compared to the image obtained in (3) to determine the particles present on the regions other than the regions of the residual external additive and/or filler (other than the regions excluded in (3)) as the resin particles. A distance between the resin particles next to one another (i.e., a distance between a center of one resin particle and a center of another resin particle) was measured using the image processing software.

The distance was measured on 100 binarized images (one toner particle per image), and an average value of the measured values is determined as the distance between the resin particles.

The standard deviation of the distance between the resin particles was calculated by the following mathematical formula, where x was a distance between the resin particles.

$$\sqrt{\frac{1}{n - 1}} {\sum }_{k = 1}^{n} ( {x}_{i} - \overline{x} )$$

### [Image Capturing Conditions]

Scanning electron microscope: SU-8230 (available from Hitachi High-Tech Corporation)
Image capturing magnification: 35,000×
Captured image: secondary electron (SE(L)) image,
backscattered electron (BSE) image
Acceleration voltage: 2.0 kV
Acceleration current: 1.0 μA
Probe current: Normal
Focus mode: UHR

### WD: 8.0 mm

### Example 2

### <Production of Toner (T-2)>

An external additive treatment was performed and Toner (T-2) was obtained in the same manner as in Example 1, except that External Additive A was replaced with External Additive B. The average value of the distances between the resin particles was measured in the same manner with Toner (T-1) in Example 1, the average value of the distances between the resin particles of Toner (T-2) was 120 nm, and the standard deviation of the distance between the resin particles was 63 nm.

### Example 3

### <Production of Toner (T-3)>

A composite resin particle (C-2) aqueous dispersion liquid where the composite resin particles included resin particles (B′-1) and particles including resin particles (A-2) deposited on each resin particle (B′-1) was obtained in the same manner as in Example 1, except that 15 parts by mass of the mixture including 5 parts by mass of the particle dispersion liquid (W-1) and 10 parts by mass of the particle dispersion liquid (W0-1) was replaced with 15 parts by mass of a mixture including 10 parts by mass of particle dispersion liquid (W-2) and 5 parts by mass of particle dispersion liquid (W0-2).

Next, the obtained aqueous dispersion liquid was subjected to washing and filtering in the same manner as in Example 1. The resulting filtration cake was dried for 18 hours at 40° C. to reduce the volatile component to 0.5% by mass or less, to thereby obtain composite resin particles (C-2).

Next, an external additive treatment was performed in the same manner as in Example 1 to obtain Toner (T-3). The average value of the distances between the resin particles was measured in the same manner with Toner (T-1) in Example 1, the average value of the distances between the resin particles of Toner (T-3) was 55 nm, and the standard deviation of the distance between the resin particles was 35 nm.

### Example 4

### <Production of Toner (T-4)>

An external additive treatment was performed and Toner (T-4) was obtained in the same manner as in Example 3, except that External Additive A was replaced with External Additive B. The average value of the distances between the resin particles was measured in the same manner with Toner (T-1) in Example 1, the average value of the distances between the resin particles of Toner (T-4) was 55 nm, and the standard deviation of the distance between the resin particles was 35 nm.

### Example 5

### <Production of Toner (T-5)>

A composite resin particle (C-5) aqueous dispersion liquid where the composite resin particles included resin particles (B′-1) and particles including resin particles (A-5) were deposited on each resin particle (B′-1) was obtained in the same manner as in Example 1, except that 15 parts by mass of the mixture including 5 parts by mass of the particle dispersion liquid (W-1) and 10 parts by mass of the particle dispersion liquid (W0-1) was replaced with 15 parts by mass of a mixture including 3 parts by mass of the particle dispersion liquid (W-1) and 12 parts by mass of the particle dispersion liquid (W0-1).

Next, the obtained aqueous dispersion liquid was subjected to washing and filtering in the same manner as in Example 1. The resulting filtration cake was dried for 18 hours at 40° C. to reduce the volatile component to 0.5% by mass or less, to thereby obtain composite resin particles (C-5).

Next, an external additive treatment was performed in the same manner as in Example 1 to obtain Toner (T-5). The average value of the distances between the resin particles was measured in the same manner with Toner (T-1) in Example 1, the average value of the distances between the resin particles of Toner (T-5) was 600 nm, and the standard deviation of the distance between the resin particles was 560 nm.

### Example 6

### <Production of Toner (T-6)>

An external additive treatment was performed and Toner (T-6) was obtained in the same manner as in Example 5, except that External Additive A was replaced with External Additive B. The average value of the distances between the resin particles was measured in the same manner with Toner (T-1) in Example 1, the average value of the distances between the resin particles of Toner (T-6) was 600 nm, and the standard deviation of the distance between the resin particles was 560 nm.

### Comparative Example 1

### <Production of Toner (T′-1)>

A composite resin particle (C′-1) aqueous dispersion liquid where the composite resin particles included resin particles (B′-1) and particles including resin particles (A′-1) deposited on each resin particle (B′-1) was obtained in the same manner as in Example 1, except that 15 parts by mass of the mixture including 5 parts by mass of the particle dispersion liquid (W-1) and 10 parts by mass of the particle dispersion liquid (W0-1) was replaced with 15 parts by mass of the particle dispersion liquid (W0-2).

Next, the obtained aqueous dispersion liquid was subjected to washing and filtering in the same manner as in Example 1. The resulting filtration cake was dried for 18 hours at 40° C. to reduce the volatile component to 0.5% by mass or less, to thereby obtain composite resin particles (C′-1).

Next, an external additive was performed in the same manner as in Example 1 to obtain Toner (T′-1). Since the resin particles B (type: B-2) were removed during the washing, the average value of distances between the resin particles of the toner (T′-1) and the standard deviation of the distance between the resin particles could not be measured.

### Comparative Example 2

### <Production of Toner (T′-2)>

An external additive was performed and Toner (T′-2) was obtained in the same manner as in Example 1, except that External Additive A was replaced with External Additive C. The average value of the distances between the resin particles was measured in the same manner with Toner (T-1) in Example 1, the average value of the distances between the resin particles of Toner (T′-2) was 120 nm, and the standard deviation of the distance between the resin particles was 63 nm.

### <Production of Carrier>

To 100 parts by mass of toluene, 100 parts by mass of a silicone resin (organo straight silicone), 5 parts by mass of γ-(2-aminoethyl)aminopropyltrimethoxysilane, and 10 parts by mass of carbon black were added. The resulting mixture was dispersed by means of a homomixer for 20 minutes to prepare a resin layer coating liquid.

The resin layer coating liquid was applied onto surfaces of spherical magnetite particles (1,000 parts by mass) having the volume average particle diameter of 50 μm by means of a fluidized bed coater, to thereby produce a carrier.

### <Production of Developer>

By means of a ball mill, 5 parts by mass of each toner, and 95 parts by mass of the carrier were mixed to produce each developer.

Next, Tg1st of each toner, Tga1st of the THF-insoluble component of each toner, and Tg2nd of the THF-soluble component of each toner were measured in the following manner. The results are presented in Tables 4 and 5.

### <Measurements of Tg1st of Toner, Tga1st of THF-Insoluble Component, and Tg2nd of THF-Soluble Component>

One gram of the toner was added to 100 mL of THF, and Soxhlet extraction was performed to obtain a THF-soluble component and THF-insoluble component of the toner. The THF-soluble component and the THF-insoluble component were dried by means of a vacuum drier for 24 hours to obtain a THF-soluble polyester resin component from the THF-soluble component and a THF-insoluble polyester resin component from the THF-insoluble component. The obtained THF-soluble polyester resin component and THF-insoluble polyester resin component were provided as measurement samples. Moreover, the toner was provided as a measurement sample for measuring Tg1st of the toner, and Tg2nd of the toner.

Next, 5.0 mg of the measurement sample was placed in a sample container formed of aluminium, the sample container was placed on a holder unit, and the holder unit was set in an electric furnace. Subsequently, the measurement sample was heated from −80° C. to 150° C. in a nitrogen atmosphere at a heating rate of 1.0° C./min (first heating). Then, the measurement sample was cooled from 150° C. down to −80° C. at a cooling rate of 1.0° C./min, followed by again heating up to 150° C. at a heating rate of 1.0° C./min (second heating). DSC curves of the first heating and the second heating were each measured by means of a differential scanning calorimeter (Q-200, available from TA Instruments Japan Inc.).

The DSC curve of the first heating was selected from the obtained DSC curves using an analysis program installed in the Q-200 system, and a glass transition temperature Tg1st of the measurement sample from the first heating was determined. Similarly, the DSC curve of the second heating was selected from the obtained DSC curves, and a glass transition temperature Tg2nd of the measurement sample from the second heating was determined.

Moreover, the DSC curve of the first heating was selected from the obtained DSC curves using the analysis program installed in the Q-200 system, and an endothermic peak top temperature of the measurement sample from the first heating was determined as a melting point. Similarly, the DSC curve of the second heating was selected from the obtained DSC curves, and an endothermic peak top temperature of the measurement sample from the second heating was determined as a melting point.

Melting points and glass transition temperatures Tg of other constituent materials, such as the polyester resin component, and the release agent, are each an endothermic peak top temperature and a glass transition temperature Tg2nd of each component from the second heating, respectively, unless otherwise stated.

Moreover, a THF-insoluble component of the toner was heated from −80° C. to 150° C. at a heating rate of 1.0° C./min in a modulation mode with a modulation temperature amplitude of ±1.0° C./min (first heating). Similarly, to the above, a DSC curve was created from the obtained DSC curves by plotting a value of “reversing heat flow” on a vertical axis using the analysis program installed in the Q-200 system, and an onset value was determined as Tg. In the manner as described above, Tga1st, Tgb1st, and Tg2nd′ were determined.

Next, “low-temperature fixability,” “heat-resistant storage stability,” “cleaning properties,” “filming resistance of additive,” “image density,” “transfer unevenness,” and “reproducibility of fine lines” were evaluated on Toners (T-1) to (T-6), and Developers (T′-1) to (T′-2) in the following manner. The results are presented in Tables 4-1, 4-2, and 5.

### <Low-Temperature Fixability>

Each toner was deposited on a surface of paper (recycled PPC sheet 100, available from Oji Paper Co., Ltd.) to be a deposition amount of 0.8 mg/cm². For depositing the toner on the surface of the paper, a printer (imagio MP C4500, available from Ricoh Company Limited) from which a thermal fixing device was removed was used.

The minimum fixing temperature (MFT) when the resulting paper was passed through a nip between a heating roller and a press roller at a fixing speed (circumferential speed of the heating roller) of 213 mm/sec, and fixing pressure (pressure of the press roller) of 10 kg/cm² was measured, and low-temperature fixability was evaluated based on the following evaluation criteria. The lower the minimum fixing temperature (MFT) is, the better low-temperature fixability of the toner is.

### [Evaluation Criteria]

Excellent: The MFT was 130° C. or lower.
Good: The MFT was higher than 130° C. and 135° C. or lower.
Fair: The MFT was higher than 135° C. and 140° C. or lower.
Poor: The MFT was higher than 140° C.

### <Heat-Resistant Storage Stability>

After storing each toner for 8 hours at 50° C., the resulting toner was sieved through a 42-mesh sieve for 2 minutes, and the residual rate on the mesh was measured. Heat-resistant storage stability of the toner was evaluated based on the following evaluation criteria. The smaller the residual rate is, the more excellent the heat-resistant storage stability of the toner is.

### [Evaluation Criteria]

Excellent: The residual rate was less than 5%.
Good: The residual rate was 5% or greater and less than 15%.
Fair: The residual rate was 15% or greater and less than 30%.
Poor: The residual rate was 30% or greater.

### <Cleaning Properties (or Toner Contamination of Photoconductor)>

A chart having an imaging area rate of 5% was printed on 50,000 sheets (A4-size, in landscape orientation) by means of an image forming apparatus (imageo MP C5002, available from Ricoh Company Limited) under a laboratory environment of 21° C. and 65% RH at 3 prints per job. The 50,000 sheets were output in the following manner.

Thereafter, as an evaluation image, a 3-line chart having a longitudinal band pattern (aligned with a traveling direction of a sheet), where each band had a band width of 43 mm, was printed on 100 sheets (A4 size landscape) in a laboratory environment of 32° C. and 54% RH. The obtained images were observed with naked eye. Cleaning properties were evaluated from the presence or absence of an image defect due to a cleaning failure based on the following evaluation criteria.

### [Evaluation Criteria]

Excellent: The toner particles passed through a cleaning blade due to a cleaning failure were not confirmed on a printed sheet nor on a photoconductor by observation with naked eye, and linear marks formed of toner residues were not confirmed as the photoconductor was observed under a microscope along a longitudinal direction.
Good: The toner particles passed through a cleaning blade due to a cleaning failure were not confirmed on a printed sheet nor on a photoconductor by observation with naked eye.
Poor: The toner particles passed through a cleaning blade due to a cleaning failure were confirmed on a printed sheet and on a photoconductor by observation with naked eye.

### <Filming Resistance of Additive (Inorganic Particles)>

By means of an image forming apparatus (imageo MP C5002, available from Ricoh Company Limited), a longitudinal band chart having an imaging area rate of 30% was printed on 5,000 sheets (A4-size, in landscape orientation) at 3 prints per job in a laboratory environment of 27° C. and 90% RH, followed by outputting 5,000 blank sheets (A4-size, in landscape orientation). Then, a half-tone image was printed on one sheet. Thereafter, the photoconductor was observed with naked eye. Filming resistance of the additive was evaluated based on the following evaluation criteria.

### [Evaluation Criteria]

Excellent: There was no problem with the photoconductor, and no problem in image quality.
Good: Slight filming occurred along the printing direction, but there was no problem in image quality.
Poor: Filming clearly occurred on the photoconductor, and there was a problem in image quality.

### <Image Density>

A solid image was formed on copy paper (TYPE 6000<70W>, available from Ricoh Company Limited) with a developer deposition amount of 1.00±0.05 mg/cm² by means of a tandem color electrophotographic apparatus (imagio Neo 450, available from Ricoh Company Limited) with setting the surface temperature of the fixing roller to 160° C.±2° C. After continuously outputting the solid image on 30,000 sheets in the above-described manner, image density was measured at 6 points randomly selected on the solid image of the 30,000^{th} sheet by means of a spectrometer (938 Spectrodensitometer, available from X-Rite). Image density was evaluated based on the following evaluation criteria. An average value of the values of the image density measured from the 6 points was used as a value of the image density. B or better results mean that the developer is suited for practical use.

### [Evaluation Criteria]

A: 2.0 or greater
B: 1.70 or greater and less than 2.0
C: less than 1.70

### <Transfer Unevenness>

The presence or absence of density unevenness (i.e., transfer unevenness) in the solid image due to a transfer failure was observed with naked eye. The solid image was formed in the same manner as in the evaluation method of the image density. The transfer unevenness was evaluated based on the following criteria.

### [Evaluation Criteria]

A: Density unevenness was not observed at all.
B: Density unevenness was not appreciably observed.
C: Density unevenness was observed, which did not adversely affect practical use.
D: Density unevenness was observed, which adversely affected practical use.
E: Significant density unevenness was observed, which inhibited practice use.

### <Reproducibility of Fine Lines>

A single-dotted lattice-line image having a pattern of 600 dots per inch and 150 lines per inch both in the main scanning direction and in the sub-scanning direction was formed on copy paper (TYPE 6000<70W>, available from Ricoh Company Limited) by means of a tandem color electrophotographic apparatus (imagio Neo 450, available from Ricoh Company Limited). After continuously outputting the line image on 30,000 sheets, breakages or patchiness in the line image were observed with naked eye. Reproducibility of fine lines was evaluated based on the following evaluation criteria.

### [Evaluation Criteria]

A: There was no breakage or patchiness in the line image
B: There was not considerably many breakages nor considerably a great degree of patchiness.
C: The breakage or patchiness was observed in the line image, which did not adversely affect practical use.
D: The breakage or patchiness was observed in the line image, which adversely affected practical use.
E: A considerable degree of breakages or patchiness was observed in the line image, which inhibited practical use.

TABLE 4-1

| | | Ex. 1 | Ex. 2 | Ex. 3 |
|---|---|---|---|---|
| Structure of toner | | core- | core- | core- |
| | | shell | shell | shell |
| | | structure | structure | structure |
| Toner | | T-1 | T-2 | T-3 |
| Constituent material of | | styrene- | styrene- | styrene- |
| toner base particles | | acrylic | acrylic | acrylic |
| | | resin | resin | resin |
| Type of resin particles A | | A-1 | A-1 | A-2 |
| Particle diameter of | | 17.3 | 17.3 | 34.3 |
| resin particles A [nm] | | | | |
| Type of resin particles B | | B-1 | B-1 | B-2 |
| Particle diameter of | | 15 | 15 | 30 |
| resin particles B [nm] | | | | |
| Resin a2/resin a1 ratio | | 1/2 | 1/2 | 1/2 |
| (in resin particle A) | | | | |
| Blending ratio (resin | | 1/2 | 1/2 | 2/1 |
| particles A/resin | | | | |
| particles B) | | | | |
| Average value of | | 120 | 120 | 55 |
| distances between resin | | | | |
| particles [nm] | | | | |
| Standard deviation of | | 63 | 63 | 35 |
| distance between resin | | | | |
| particles [nm] | | | | |
| Tg1st of Toner [° C.] | | 42 | 42 | 46 |
| Tg1st of THF-insoluble | | −37 | −37 | −37 |
| component of toner[° C.] | | | | |
| Tg2nd of THF-soluble | | 57 | 57 | 57 |
| component of toner [° C.] | | | | |
| Washing | | performed | performed | performed |
| Type of external additive | | A | B | A |
| Evalua- | low-temperature | Excellent | Excellent | Good |
| tion | fixability | | | |
| result | heat-resistant | Excellent | Good | Excellent |
| | storage | | | |
| | stability | | | |
| | cleaning | Excellent | Good | Excellent |
| | properties | | | |
| | filming | Excellent | Excellent | Excellent |
| | resistance of | | | |
| | additive | | | |
| | image density | A | B | A |
| | transfer | A | B | A |
| | unevenness | | | |
| | fine-line | A | B | B |
| | reproducibility | | | |

TABLE 4-2

| | | Ex. 4 | Ex. 5 | Ex. 6 |
|---|---|---|---|---|
| Structure of toner | | core- | core- | core- |
| | | shell | shell | shell |
| | | structure | structure | structure |
| Toner | | T-4 | T-5 | T-6 |
| Constituent material of | | styrene- | styrene- | styrene- |
| toner base particles | | acrylic | acrylic | acrylic |
| | | resin | resin | resin |
| Type of resin particles A | | A-2 | A-1 | A-1 |
| Particle diameter of resin | | 34.3 | 17.3 | 17.3 |
| particles A [nm] | | | | |
| Type of resin particles B | | B-2 | B-1 | B-1 |
| Particle diameter of resin | | 30 | 15 | 15 |
| particles B [nm] | | | | |
| Resin a2/resin a1 ratio (in | | 1/2 | 1/2 | 1/2 |
| resin particle A) | | | | |
| Blending ratio (resin | | 2/1 | 1/4 | 1/4 |
| particles A/resin particles | | | | |
| B) | | | | |
| Average value of distances | | 55 | 600 | 600 |
| between resin particles [nm] | | | | |
| Standard deviation of | | 35 | 560 | 560 |
| distance between resin | | | | |
| particles [nm] | | | | |
| Tg1st of Toner [° C.] | | 46 | 41 | 41 |
| Tg1st of THF-insoluble | | −37 | −37 | −37 |
| component of toner [° C.] | | | | |
| Tg2nd of THF-soluble | | 57 | 57 | 57 |
| component of toner [° C.] | | | | |
| Washing | | performed | performed | performed |
| Type of external additive | | B | A | B |
| Evalua- | low-temperature | Good | Good | Good |
| tion | fixability | | | |
| result | heat-resistant | Good | Good | Good |
| | storage stability | | | |
| | cleaning | Excellent | Excellent | Good |
| | properties | | | |
| | filming resistance | Excellent | Good | Good |
| | of additive | | | |
| | image density | B | B | B |
| | transfer | B | B | C |
| | unevenness | | | |
| | fine-line | B | B | C |
| | reproducibility | | | |

TABLE 5

| | | Comp. | Comp. |
|---|---|---|---|
| | | Ex. 1 | Ex. 2 |
| Structure of toner | | core-shell | core-shell |
| | | structure | structure |
| Toner | | T′-l | T′-2 |
| Constituent material of toner | | styrene- | styrene- |
| base particles | | acrylic | acrylic |
| | | resin | resin |
| Type of resin particles A | | NA | A-1 |
| Particle diameter of resin | | NA | 17.3 |
| particles A [nm] | | | |
| Type of resin particles B | | B-2 | B-1 |
| Particle diameter of resin | | 30 | 15 |
| particles B [nm] | | | |
| Resin a2/resin a1 ratio (in resin | | NA | 1/2 |
| particle A) | | | |
| Blending ratio (resin particles | | 0/1 | 1/2 |
| A/resin particles B) | | | |
| Average value of distances | | NA | 120 |
| between resin particles [nm] | | | |
| Standard deviation of distance | | NA | 63 |
| between resin particles [nm] | | | |
| Tg1st of Toner [° C.] | | 40 | 42 |
| Tg1st of THF-insoluble component | | −37 | −37 |
| of toner [° C.] | | | |
| Tg2nd of THF-soluble component of | | 57 | 57 |
| toner [° C.] | | | |
| Washing | | performed | performed |
| Type of external additive | | A | C |
| Evalua- | low-temperature fixability | Good | Excellent |
| tion | heat-resistant storage | Poor | Good |
| results | stability | | |
| | cleaning properties | Poor | Good |
| | filming resistance of | Good | Excellent |
| | additive | | |
| | image density | C | C |
| | transfer unevenness | C | E |
| | fine-line reproducibility | D | D |

For example, embodiments of the present disclosure are as follows.

<1> A toner including:

toner base particles each including a binder resin and a releasing agent;
resin particles; and
an external additive,
wherein resin particles, from among the resin particles comprised in the toner, and the external additive are deposited on a surface of each of the toner base particles,
wherein a standard deviation of a distance between resin particles next to one another on the surface of each of the toner base particles is less than 600 nm, the resin particles next to one another being from among the resin particles deposited on the surface,
wherein the external additive includes primary particles each standing alone and non-spherical cohesive particles each including primary particles that are cohered, and
wherein a proportion of the primary particles each standing alone per 1,000 particles of the external additive is 30% or less, the particles of the external additive in the per 1,000 particles of the external additive being the primary particles each standing alone and the non-spherical cohesive particles.

<2> The toner according to <1>, wherein the standard deviation of the distance between the resin particles next to one another is 250 nm or less.

<3> The toner according to <1> or <2>, wherein an average value of the distance between the resin particles next to one another is 10 nm or greater and 500 nm or less.

<4> The toner according to any one of <1> to <3>,

wherein each of the resin particles includes a core resin, and a shell resin covering at least part of a surface of the core resin.

<5> The toner according to <4>, wherein the shell resin includes a styrene-acrylic resin.

<6> The toner according to any one of <1> to <5>,

wherein the external additive satisfies Formula (1-1):

$$\frac{{N}_{x}}{1 , 000} \times 100 \leq 20 \% \qquad Formula ( 1 - 1 )$$

where Nₓ is the number of the primary particles standing alone.

<7> The toner according to any one of <1> to <6>,

wherein a volume average particle diameter of the non-spherical cohesive particles is 15 nm or greater and 400 nm or less.

<8> A toner storage unit including:

the toner according to any one of <1> to <7>; and a unit in which the toner is stored.

<9> An image forming apparatus including:

the toner storage unit according to <8>;
a transferring unit; and
a fixing unit,
wherein the toner storage unit includes an electrostatic latent image bearer, and a developing unit configured to develop an electrostatic latent image formed on the electrostatic latent image bearer with the toner to form a visible image, and
wherein the transferring unit is configured to transfer the visible image formed on the electrostatic latent image bearer to a recording medium, and the fixing unit is configured to fix the transferred visible image on the recording medium.

<10> An image forming apparatus including: the toner according to any one of <1> to <7>; an electrostatic latent image bearer;

an electrostatic latent image forming unit configured to form an electrostatic latent image on the electrostatic latent image bearer; and
a developing unit that stores the toner and is configured to develop the electrostatic latent image formed on the electrostatic latent image bearer with the toner to form a visible image.

<11> An image forming method including:

forming an electrostatic latent image on an electrostatic latent image bearer;
developing the electrostatic latent image formed on the electrostatic latent image bearer with the toner according to any one of <1> to <7> to form a visible image;
transferring the visible image formed on the electrostatic latent image bearer to a recording medium; and
fixing the transferred visible image on the recording medium.

<12> A toner production method, including:

depositing resin particles on surfaces of toner base particles to form composite particles; and
removing part of the resin particles from the composite particles to produce the toner according to any one of <1> to <7>.
<13> The toner production method according to <12>,
wherein the removing is washing the composite particles with a basic aqueous solution.

The toner according to any one of <1> to <7>, the toner storage unit according to <8>, the image forming apparatus according to <9> or <10>, the image forming method according to <11>, and the toner production method according to <12> or <13> can solve the above-described various problems existing in the art, and can achieve the object of the present disclosure.

What is claimed is:

1. A toner comprising:
toner base particles each including a binder resin and a releasing agent;
resin particles; and
an external additive,
wherein resin particles, from among the resin particles comprised in the toner, and the external additive are deposited on a surface of each of the toner base particles,
wherein a standard deviation of a distance between resin particles next to one another on the surface of each of the toner base particles is less than 600 nm, the resin particles next to one another being from among the resin particles deposited on the surface,
wherein the external additive includes primary particles each standing alone and non-spherical cohesive particles each including primary particles that are cohered, and
wherein a proportion of the primary particles each standing alone per 1,000 particles of the external additive is 30% or less, the particles of the external additive in the per 1,000 particles of the external additive being the primary particles each standing alone and the non-spherical cohesive particles.

2. The toner according to claim 1, wherein the standard deviation of the distance between the resin particles next to one another is 250 nm or less.

3. The toner according to claim 1, wherein an average value of the distance between the resin particles next to one another is 10 nm or greater and 500 nm or less.

4. The toner according to claim 1, wherein each of the resin particles includes a core resin, and a shell resin covering at least part of a surface of the core resin.

5. The toner according to claim 4, wherein the shell resin includes a styrene-acrylic resin.

6. The toner according to claim 1, wherein the proportion of the primary particles each standing alone per 1,000 particles of the external additive is 20% or less.

7. The toner according to claim 1, wherein a volume average particle diameter of the non-spherical cohesive particles is 15 nm or greater and 400 nm or less.

8. A toner storage unit comprising:
the toner according to claim 1; and
a unit in which the toner is stored.

9. An image forming apparatus comprising:
the toner storage unit according to claim 8;
a transferring unit; and
a fixing unit,
wherein the toner storage unit includes an electrostatic latent image bearer, and a developing unit configured to develop an electrostatic latent image formed on the electrostatic latent image bearer with the toner to form a visible image, and
wherein the transferring unit is configured to transfer the visible image formed on the electrostatic latent image bearer to a recording medium, and the fixing unit is configured to fix the transferred visible image on the recording medium.

10. An image forming apparatus comprising:
the toner according to claim 1;
an electrostatic latent image bearer;
an electrostatic latent image forming unit configured to form an electrostatic latent image on the electrostatic latent image bearer; and
a developing unit that stores the toner and is configured to develop the electrostatic latent image formed on the electrostatic latent image bearer with the toner to form a visible image.

11. An image forming method comprising:
forming an electrostatic latent image on an electrostatic latent image bearer;
developing the electrostatic latent image formed on the electrostatic latent image bearer with the toner according to claim 1 to form a visible image;
transferring the visible image formed on the electrostatic latent image bearer to a recording medium; and
fixing the transferred visible image on the recording medium.
